(19) United States
(12) Patent Application Publication
(10) Pub. No.: US 2012/0215563 A1
(43) Pub. Date: Aug. 23, 2012

(54) ADMINISTRATION OF BUNDLED HEALTH CARE PRICING

(76) Inventors: Tobin S. Lassen, Houston, TX (US); John W. Adams, JR., Houston, TX (US); Claudia C. Melendez, Houston, TX (US); Shannon T. Riley, Pearland, TX (US); Yvonne Marie Barrow, Jersey Village, TX (US); Karen L. Davenport, Richmond, TX (US); Juan N. de Bedout, Houston, TX (US)

(21) Appl. No.: 13/401,681

(22) Filed: Feb. 21, 2012

Related U.S. Application Data
(60) Provisional application No. 61/444,946, filed on Feb. 21, 2011.

(51) Int. Cl. G06Q 50/22; G06Q 50/24

(52) U.S. Cl. 705/3; 705/2

(57) ABSTRACT

A system and process for administration of bundled health care pricing, packaged health care, case rates, or episodes of care. The system may include software to automate administrative functions. The disclosure relates to processes including the steps of distributing payments, calculating savings, and processing claims associated with bundled health care pricing.

### RELATED APPLICATIONS

This application claims priority to U.S. Provisional Application No. 61/444,946, entitled “ADMINISTRATION OF BUNDLED HEALTH CARE PRICING,” filed Feb. 21, 2011, and which is hereby incorporated by reference for all purposes.

### FIELD OF THE INVENTION

The present disclosure relates generally to the field of administration of bundled health care pricing, and more specifically to a process for administrating and coordinating patient information, insurance beneficiary information, health care bundle fee schedules, payments for services associated with bundled health care pricing, and other aspects of providing bundled services.

### BACKGROUND

Increasing health care costs in recent decades have resulted in demand for package pricing for related health care services. Packaged or bundled health care plans may in some cases provide lower costs to patients based on improved coordination between service providers and medical facilities. In fact, the United States Congressional Budget Office estimates that bundling payments can cut national healthcare costs by 5.4%. Since the Patient Protection and Affordable Care Act was signed into law on Mar. 23, 2010, managed care provider networks in the form of “Accountable Care Organizations” (ACOs) have also become increasingly popular due to the Shared Savings programs outlined in the law, particularly due to bundling.

While ACOs envision working within large integrated healthcare delivery systems on an enterprise platform and by employing physicians under their control, the present disclosure is unique in that it addresses independent practitioners coming together under bundles through technology and process.

Therefore, there is a need to coordinate interactions between patients and increasingly complex provider networks. The present disclosure provides a process for administrating such interactions.

### SUMMARY

The present disclosure relates to systems and methods for administration of bundled health care pricing, which may include the steps of distributing payments, calculating savings, and processing claims associated with bundled health care pricing. The disclosure further comprises process steps for managing a risk pool which receives fees and pays costs associated with bundled, packaged, or episodic health care plans. The disclosed system and method calculates cost or savings on each patient based on the services required to treat the patient. A patient with more complications and/or inefficient provision of care generates a cost for the risk pool because more services or more expensive services are required to treat that patient. A patient without comorbidities and complications and/or efficient provision of care may generate savings to the risk pool, because he/she requires fewer services and the cost of his/her services are less than the set fee under the bundled, packaged, or episodic rate.

In certain embodiments, the disclosure comprises assembling a group of physicians and other healthcare providers, wherein the members of the group have a financial stake in the group. A database of patient information containing both financial and clinical data may be formed using information from a specific group of beneficiaries or from patients that have already received services.

The disclosure also comprises generating one or more health care bundles based on the medical needs of the beneficiaries or patients. Health care bundles may include acute, inpatient hospital services, physician services, outpatient hospital services, post-acute care services, and are intended to include all services which may be related to a given medical event. The services may be provided by multiple physicians or at multiple facilities. Health care bundles will be associated with a fixed healthcare bundle fee.

The disclosure further comprises software, which may perform process steps including the linking or bundling of all associated healthcare services and claims to the specific case, bundle, episode or packaged service, the computation of additional outlier payments due to complications, if applicable, paying fees to physicians and health care providers for services, collecting fees for the health care bundle from beneficiaries, employer groups, or secondary carriers, and the administration of a risk pool. The software may collect information on actual health care bundles for a database, including diagnosis, surgical procedures, postoperative courses, medical history information, and personal demographic data.

### BRIEF DESCRIPTION OF THE DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 shows a flow chart for a bundled pricing process, in an embodiment of the present disclosure;

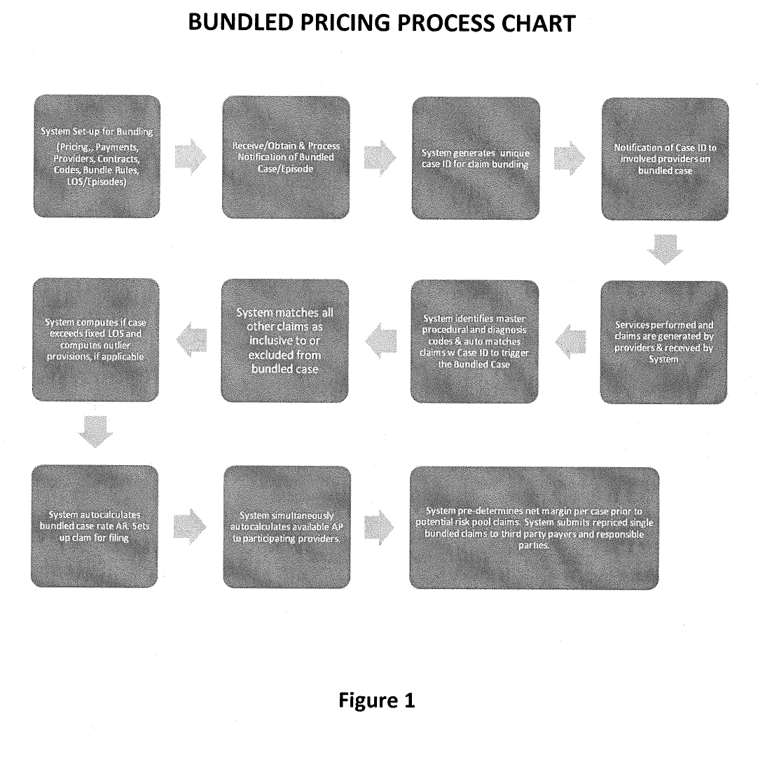

FIG. 2 shows a flow chart for a bundled payment process, in an embodiment of the present disclosure;

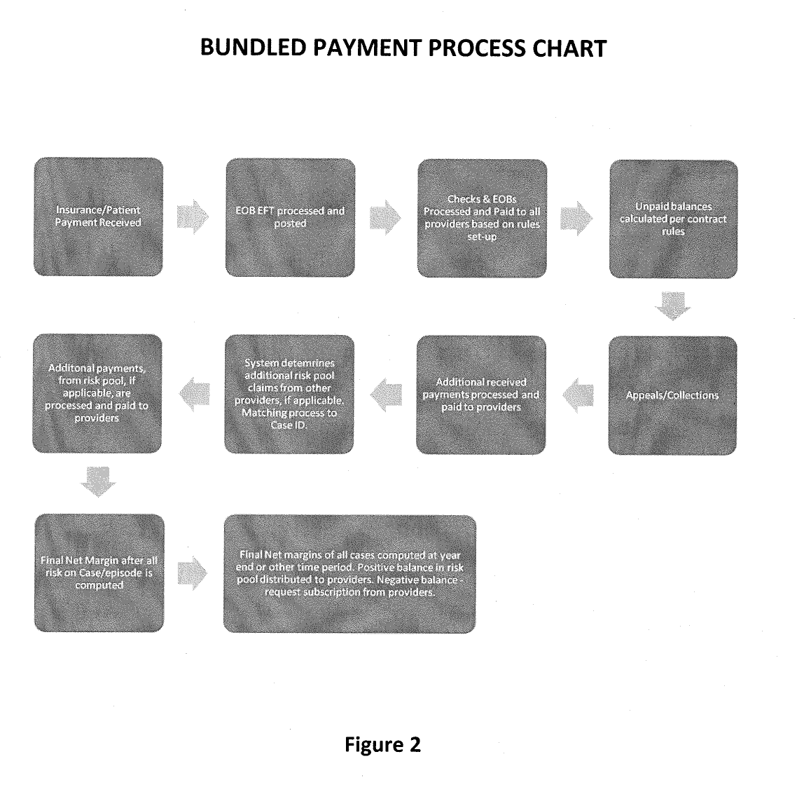

FIG. 3 shows an exemplary embodiment of the disclosure for pricing of a coronary artery bypass graft package;

FIG. 4 shows a bundled pricing and posting process, starting with the rendering and billing of services from medical service providers, in an embodiment of the present disclosure;

FIG. 5 shows an overview of the administration process with Managed Care Provider Organizations in an embodiment of the present disclosure;

FIG. 6 shows a summary of required personnel, contracting, and system tools to administer and embodiment of the present disclosure;

FIG. 7 shows an overview of the communication methods and protocols to support an embodiment of the present disclosure;

FIG. 8 shows an exemplary episode of care break down in accordance with the present disclosure;

FIG. 9 shows the administration of claims bundling and operation in accordance with the present disclosure, featuring a hierarchy of claims system processes;

FIG. 10 shows a hierarchy of payment posting system processes in an embodiment of the present disclosure;

FIG. 11 shows the components of a submitted claim and transmitted package in an embodiment of the present disclosure;

FIG. 12 shows pricing setup and package components as it relates to the pricing engine for an embodiment of the present disclosure;

FIG. 13 shows a diagram of the Pricing Engine Components for the present disclosure;

FIG. 14 shows the breakdown of claims transformation into packages or cases in an embodiment of the present disclosure;

FIG. 15 shows an overview of the required infrastructure to support an embodiment of the present disclosure.

### DETAILED DESCRIPTION

The present disclosure relates generally to a system and process for administration of bundled health care pricing, packaged health care, case rates, or episodes of care. The system can be implemented in hardware or a suitable combination of hardware and software, such as one or more software systems operating on a general purpose processing platform. As used herein, a hardware system can include discrete semiconductor devices, an application-specific integrated circuit, a field programmable gate array, a general purpose processing platform, or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

The system may include software systems that are configured to automate administrative functions. In some embodiments, the disclosure relates to processes including the steps of distributing payments, calculating savings, and processing claims associated with bundled health care pricing.

In certain embodiments, the disclosure includes a group of physicians and other health care providers that share in either profit or loss on services provided during the year at a bundled, packaged, or episodic case rate. Profit or loss may be calculated from one or more data fields using a risk pool. The risk pool is an account which receives data that identifies fixed fees for bundled, packaged, or episodic health care plans, and which correlates that data with that that identifies payment of fees for the cost of services associated with the bundled, packaged, or episodic health care provided. The risk pool data may show a profit or loss over a given time period, for example annually. A bonus may be paid to the group of health care providers when the risk pool data shows a profit, and a subscription may be charged to the group when the risk pool data shows a loss.

The disclosure further comprises software systems that are configured to manage the risk pool. The software systems can include one or more algorithms that calculate cost or savings on each patient based on data fields that identify the services required to treat the patient. A patient with more complications and/or inefficient provision of care generates a cost for the risk pool because more services or more expensive services are required to treat that patient. A patient without comorbidities and complications and/or efficient provision of care may generate savings to the risk pool, because he/she requires fewer services and the cost of his/her services are less than the set fee under the bundled, packaged, or episodic rate.

Incentives may also be added to the risk pool, for example by the hospital or other entity administering the group. Incentives include payments to physicians, medical providers, or groups of medical providers based on savings on supply costs or other costs.

The present disclosure also includes software systems for use in administration of bundled healthcare pricing, packaged healthcare, case rates, or episodes of care. The software includes algorithms that are capable of receiving, storing, and transmitting one or more data fields that are used to store pricing data for cases, payment data, provider identifiers, contract data, and data fields containing master codes for cases, packages, bundles or episodes, bundling rules, and length of stay (LOS)/episode, case or package. The algorithms can also carry out any of the following steps: a) receiving and storing information associated with a bundled case episode; b) generating a unique case ID for the bundled case episode; c) generation of notification of the unique case ID to the providers who will provide services for the bundled case; d) electronically receiving claims for services which are generated by providers, both facility and professional; e) electronically identifying a specific claim with master procedural and diagnosis codes that triggers a specific case rate or bundle price (previously set-up) and then automatically matching one or more other claims (as either inclusive to or excluded from the bundle) to the case ID of the identified bundled case; f) electronically matching each claim associated with the bundled episode or case to determine whether it is inclusive or exclusive of the LOS for the bundled case rate; g) electronically determining whether the case exceeds the fixed LOS for the identified bundle, package or episode as set-up in the database, and computing outlier provisions, if applicable; h) automatically calculating the case rate for the bundled case including any additional outlier billings, if applicable, for accounts receivable (AR); i) automatically calculating the accounts payable (AP) to providers on the case, both facility and professional; j) electronically calculating net margin per case prior to potential risk pool claims; k) submitting the single, repriced bundled claim to a third party payer and/or other responsible party; l) automatically providing claim status to each provider on the case, through the system and internet, including but not limited to billed, in process, denied for more information required, or paid.

The software systems of the present disclosure may also be capable of carrying out any of the following steps: a) receiving payment from insurance companies, employer groups, other third party payers and/or or individual patients; b) receiving and processing electronic funds transfer (EFT) or other forms of payment, an explanation of benefits (EOB) on a case, and posting of payments on a case, which may include electronic, automatic posting; c) processing payment and providing EOBs to one or more providers on a case, which may include EFT and electronic EOB processing, based on rules set-up for the bundled case; d) calculating unpaid balances per contract rules; e) calculating and routing amounts subject to appeals or collections and processing additional payments to providers; f) linking or bundling one or more other potential, additional claims which may be inclusive to the case and processing and paying additional payments from risk pool, if applicable, to such providers; g) determining a final net margin after risk data for the case, package or episode is computed; and h) determining a final net margin of one or more cases computed at year end, or other such time frame, and distributing positive balance in the risk pool to providers, or requesting subscription from providers if a negative balance exists in the risk pool; i) the system may utilize the database to report on prospective financial and clinical risk of cases, episodes, packages or bundles already processed.

The group of physicians and other healthcare providers of the present disclosure may provide services to a specific group of patients or beneficiaries. The group may be assembled such that every aspect of care for common medical events could be covered by a member of the group. Considerations for assembling the group include how many medical professionals in each specialty area are required to serve the defined group of beneficiaries, minimum length of time that physicians and other healthcare providers can agree to participate in the group, and how patient data will be tracked to support evidence-based medicine, quality and cost control, and efficient coordination of care.

In certain embodiments of the disclosure, a database of patient information will be generated using information from the specific group of beneficiaries or from patients that have already received services. The database may include information on diagnosis, surgical procedures, postoperative courses, medical history information, and personal demographic data. The database may also include outcome data for patients who have already received services.

In certain embodiments of the disclosure, one or more health care bundles will be derived from the medical needs of the beneficiaries or patients. Health care bundles may include acute, inpatient hospital services, physician services, outpatient hospital services, post-acute care services, and are intended to include one or more services which may be related to a given medical event. The services may be provided by multiple physicians or at multiple facilities.

In certain embodiments, the disclosure comprises the calculation of a fee for a given health care bundle. The fee may be calculated from the historical or estimated cost of the services involved in the health care bundle using data generated from the database. The fee may include the cost of services provided by multiple physicians or at multiple facilities, and includes the costs of providing services to one or more beneficiaries. The costs are often paid by secondary carriers or employer groups.

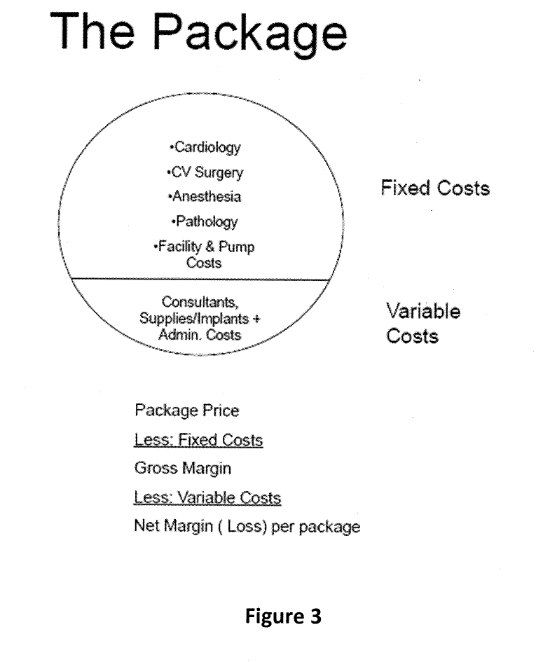

FIG. 3 shows an exemplary embodiment of the disclosure for pricing of a coronary artery bypass package. The fixed working costs are determined by consulting with each specialist involved, and the specific hospital handling a case. Once fixed costs are determined, the administrative entity uses historical database information to pre-determine its potential variable costs, i.e., how much complication risk, other consultant use and other risk pool costs that may be associated with this case, and adds that to the package. The administrative entity then calculates the administrative cost to administer this bundle or case and applies that to the price to come up with a total package or case rate. After the services are performed and actual variable costs are known, actual net margin on the case can be determined. Table 1 shows a sample of potential cardiovascular procedures which may be bundled into cases, episodes or packages. Table 2 shows a list of potential procedural codes in an example coronary artery bypass graft case as identified by the system.

TABLE 1
sample of potential procedural codes which may be bundled into case
or packaged rates.

| | |
|---|---|
| INVASIVE | Peripheral Diagnostic Study |
| DIAGNOSTIC: | Cardiac Catheterization |
| | Electrophysiologic Study |
| | Pre-Transplant Evaluation |
| INVASIVE | Percutaneous Transluminal Coronary Angioplasty |
| PROCEDURE: | (PTCA) |
| | PTCA w/Cardiac Cath. |
| | Atherectomy, Coronary |
| | Percutaneous Transluminal Angioplasty (PTA) |
| | Atherectomy, Peripheral Stent, Peripheral |
| | Permanent Pacemaker Insertion |
| | Myocardial Biopsy |
| | Auto-Implant Cardio Defibrillator |
| | EPS with Ablation Cardioversion |
| | Medical Balloon |
| | PTCA with Coronary Stent |
| | PTCA/Stent/Cath |
| | Endovascular Stent (EVS) |
| SURGICAL | Abdominal Aortic Aneurysmectomy (AAA) |
| PROCEDURE: | AAA following failed Endovascular Stent |
| | Aneurysmectomy Ascending Thoracic Aorta (AATA) |
| | Aneurysmectomy DescendingThoracic Aorta (ADTA) |
| | Aortic Valve Replacement |
| | Aortic Valve Replacement, Redo |
| | Mitral Valve Replacement |
| | Mitral Valve Replacement, Redo |
| | Aortic/Mitral Valve Replacement |
| | Mitral Valve Commissurotomy or Valvuloplasty |
| | Coronary Bypass |
| | CAB Redo |
| | CAB following failed PTCA |
| | Aorto-Iliac, Aorto-Femora Aorto-Popliteal Bypass |
| | Carotid or Subclavian Endarterectomy or Bypass (single) |
| | Carotid or Subclavian Endarterectomy or Bypass |
| | (bilateral) |
| | Renal Endarterectomy or Bypass |
| | Fem-Fem, Fem-Pop, Fem-Tib, Bypass w/ or w/o |
| | Endarterectomy (single) |
| | Fem-Fem, Fem-Pop, Fem-Tib, Bypass w/ or w/o |
| | Endarterectomy (bilateral) |
| | Maze Procedure |
| | Left Ventricular Aneurysmectomy or Plication |
| | Left Ventricular Assist Device Implantation |
| | or Removal - Extracorporeal (LVAD) |
| | Left Ventricular Assist Device Implantation |
| | or Removal - Intracorporeal (LVAD) |
| | Thoracoabdominal Aortic Aneurysm |
| | Transverse Aortic Arch |
| | Cardiac Transplantation |

TABLE 2
list of potential procedural codes in an example coronary artery bypass graft case.

| CPT/REV Code | Modifier 1 | Modifier 2 | CPT/REV Code Description | Specialty/Hospital |
|---|---|---|---|---|
| 36556 | 56 | | Insert non tunnel cv cath | Anesthesiology |
| 36620 | 59 | | Insertion catheter, altery | Anesthesiology |
| 00567 | P4 | | Anesth, cabg w/ pump | Anesthesiology |
| 99221 | | | INITIAL HOSPITAL CARE | Cardiology |
| 99231 | | | SUBSEQUENT HOSPITAL CARE | Cardiology |
| 99231 | | | SUBSEQUENT HOSPITAL CARE | Cardiology |
| 99231 | | | SUBSEQUENT HOSPITAL CARE | Cardiology |
| 99232 | | | SUBSEQUENT HOSPITAL CARE | Cardiology |
| 99232 | | | SUBSEQUENT HOSPITAL CARE | Cardiology |
| 99233 | | | SUBSEQUENT HOSPITAL CARE | Cardiology |
| 99233 | | | SUBSEQUENT HOSPITAL CARE | Cardiology |
| 33518 | | | CABG, ARTERY-VEIN, TWO | CV Surgery |
| 33533 | | | CABG, ARTERIAL, SINGLE | CV Surgery |
| 120 | | | ROOM-BOARD/SEMI | Hospital |
| 200 | | | INTENSIVE CARE | Hospital |
| 251 | | | DRUGS/GENERIC | Hospital |
| 252 | | | DRUGS/NONGENERIC | Hospital |
| 258 | | | IV SOLUTIONS | Hospital |
| 270 | | | MED-SUR SUPPLIES | Hospital |
| 271 | | | NONSTER SUPPLY | Hospital |
| 272 | | | STERILE SUPPLY | Hospital |
| 274 | | | PROSTH/ORTH DEV | Hospital |
| 278 | | | SUPPLY/IMPLANTS | Hospital |
| 300 | | | LABORATORY | Hospital |
| 320 | | | DX X-RAY | Hospital |
| 350 | | | CT SCAN | Hospital |
| 360 | | | OR SERVICES | Hospital |
| 370 | | | ANESTHESIA | Hospital |
| 390 | | | BLOOD/STOR-PROC | Hospital |
| 410 | | | RESPIRATORY SVC | Hospital |
| 480 | | | CARDIOLOGY | Hospital |
| 623 | | | SURG DRESSING | Hospital |
| 636 | | | DRUG/DETAIL CODE | Hospital |
| 637 | | | SELF ADMIN DRG | Hospital |
| 730 | | | EKG/ECG | Hospital |
| 740 | | | EEG | Hospital |
| 921 | | | BIL CAROTID | Hospital |
| 99232 | | | SUBSEQUENT HOSPITAL CARE | Infectious Disease |
| 99232 | | | SUBSEQUENT HOSPITAL CARE | Infectious Disease |
| 99232 | | | SUBSEQUENT HOSPITAL CARE | Infectious Disease |
| 99233 | | | SUBSEQUENT HOSPITAL CARE | Infectious Disease |
| 99254 | | | INITIAL INPATIENT CONSULT | Infectious Disease |
| 95816 | 26 | | ELECTROENCEPHALOGRAM (EEG) | Neurology |
| 95656 | 26 | | EEG MONITORING/CABLE/RADIO | Neurology |
| 95656 | 26 | 59 | EEG MONITORING/CABLE/RADIO | Neurology |
| 95656 | 26 | | EEG MONITORING/CABLE/RADIO | Neurology |
| 99232 | | | SUBSEQUENT HOSPITAL CARE | Neurology |
| 99232 | | | SUBSEQUENT HOSPITAL CARE | Neurology |
| 99255 | | | INITIAL INPATIENT CONSULT | Neurology |
| 99291 | | | E/M CRITICAL CARE (FIRST HOUR) | Neurology |
| 99291 | | | E/M CRITICAL CARE (FIRST HOUR) | Neurology |
| 99291 | | | E/M CRITICAL CARE (FIRST HOUR) | Neurology |
| 99291 | | | E/M CRITICAL CARE (FIRST HOUR) | Neurology |
| 99291 | | | E/M CRITICAL CARE (FIRST HOUR) | Neurology |
| 99291 | GC | | E/M CRITICAL CARE (FIRST HOUR) | Neurology |
| 99291 | GC | | E/M CRITICAL CARE (FIRST HOUR) | Neurology |
| 99292 | GC | | CRITICAL CARE, ADDL 30 MIN | Neurology |
| 80048 | 26 | | Basic metabolic panel | Pathology |
| 80048 | 26 | | Basic metabolic panel | Pathology |
| 80048 | 26 | | Basic metabolic panel | Pathology |
| 80048 | 26 | | Basic metabolic panel | Pathology |
| 80048 | 26 | | Basic metabolic panel | Pathology |
| 80061 | 26 | | LIPID PANEL | Pathology |
| 80061 | 26 | | LIPID PANEL | Pathology |
| 80076 | 26 | | Hepatic function panel | Pathology |
| 80076 | 26 | | Hepatic function panel | Pathology |
| 80185 | 26 | | ASSAY FOR PHENYTOIN | Pathology |
| 80185 | 26 | | ASSAY FOR PHENYTOIN | Pathology |
| 80185 | 26 | | ASSAY FOR PHENYTOIN | Pathology |
| 80202 | 26 | | ASSAY FOR VANCOMYCIN | Pathology |
| 81001 | 26 | | URINALYSIS, AUTO, W/SCOPE | Pathology |
| 82330 | 26 | | ASSAY CALCIUM | Pathology |
| 82550 | 26 | | ASSAY CK (CPK) | Pathology |
| 82550 | 26 | | ASSAY CK (CPK) | Pathology |
| 82553 | 26 | | CREATINE, MB FRACTION | Pathology |
| 82553 | 26 | | CREATINE, MB FRACTION | Pathology |
| 82565 | 26 | | ASSAY CREATININE | Pathology |
| 82565 | 26 | | ASSAY CREATININE | Pathology |
| 82565 | 26 | | ASSAY CREATININE | Pathology |
| 82803 | 26 | | BLOOD GASES: PH, PO2, PCO2 | Pathology |
| 82803 | 26 | | BLOOD GASES: PH, PO2, PCO2 | Pathology |
| 82803 | 26 | | BLOOD GASES: PH, PO2, PCO2 | Pathology |
| 82803 | 26 | | BLOOD GASES: PH, PO2, PCO2 | Pathology |
| 82803 | 26 | | BLOOD GASES: PH, PO2, PCO2 | Pathology |
| 82803 | 26 | | BLOOD GASES: PH, PO2, PCO2 | Pathology |
| 82803 | 26 | | BLOOD GASES: PH, PO2, PCO2 | Pathology |
| 82803 | 26 | | BLOOD GASES: PH, PO2, PCO2 | Pathology |
| 82947 | 26 | | ASSAY QUANTITATIVE, GLUCOSE | Pathology |
| 82947 | 26 | | ASSAY QUANTITATIVE, GLUCOSE | Pathology |
| 82947 | 26 | | ASSAY QUANTITATIVE, GLUCOSE | Pathology |
| 82947 | 26 | | ASSAY QUANTITATIVE, GLUCOSE | Pathology |
| 82947 | 26 | | ASSAY QUANTITATIVE, GLUCOSE | Pathology |
| 83735 | 26 | | ASSAY MAGNESIUM | Pathology |
| 83735 | 26 | | ASSAY MAGNESIUM | Pathology |
| 83735 | 26 | | ASSAY MAGNESIUM | Pathology |
| 83735 | 26 | | ASSAY MAGNESIUM | Pathology |
| 83735 | 26 | | ASSAY MAGNESIUM | Pathology |
| 83735 | 26 | | ASSAY MAGNESIUM | Pathology |
| 83735 | 26 | | ASSAY MAGNESIUM | Pathology |
| 83880 | 26 | | Natriuretic peptide | Pathology |
| 84100 | 26 | | ASSAY PHOSPHORUS | Pathology |
| 84100 | 26 | | ASSAY PHOSPHORUS | Pathology |
| 84132 | 26 | | ASSAY SERUM POTASSIUM | Pathology |
| 84132 | 26 | | ASSAY SERUM POTASSIUM | Pathology |
| 84295 | 26 | | ASSAY SERUM SODIUM | Pathology |
| 84484 | 26 | | TROPONIN, QUANTITATIVE | Pathology |
| 84484 | 26 | | TROPONIN, QUANTITATIVE | Pathology |
| 84520 | 26 | | ASSAY UREA NITROGEN | Pathology |
| 84520 | 26 | | ASSAY UREA NITROGEN | Pathology |
| 84520 | 26 | | ASSAY UREA NITROGEN | Pathology |
| 85014 | 26 | | HEMATOCRIT | Pathology |
| 85014 | 26 | | HEMATOCRIT | Pathology |
| 85014 | 26 | | HEMATOCRIT | Pathology |
| 85018 | 26 | | HEMOGLOBIN | Pathology |
| 85018 | 26 | | HEMOGLOBIN | Pathology |
| 85018 | 26 | | HEMOGLOBIN | Pathology |
| 85025 | 26 | | AUTOMATED HEMOGRAM | Pathology |
| 85025 | 26 | | AUTOMATED HEMOGRAM | Pathology |
| 85025 | 26 | | AUTOMATED HEMOGRAM | Pathology |
| 85025 | 26 | | AUTOMATED HEMOGRAM | Pathology |
| 85025 | 26 | | AUTOMATED HEMOGRAM | Pathology |
| 85025 | 26 | | AUTOMATED HEMOGRAM | Pathology |
| 85027 | 26 | | AUTOMATED HEMOGRAM | Pathology |
| 85049 | 26 | | Automated platelet count | Pathology |
| 85347 | 26 | | COAGULATION TIME | Pathology |
| 85576 | 26 | | BLOOD PLATELET AGGREGATION | Pathology |
| 85610 | 26 | | PROTHROMBIN TIME | Pathology |
| 85610 | 26 | | PROTHROMBIN TIME | Pathology |
| 85610 | 26 | | PROTHROMBIN TIME | Pathology |
| 85610 | 26 | | PROTHROMBIN TIME | Pathology |
| 85610 | 26 | | PROTHROMBIN TIME | Pathology |
| 85730 | 26 | | THROMBOPLASTIN TIME, PARTIAL | Pathology |
| 85730 | 26 | | THROMBOPLASTIN TIME, PARTIAL | Pathology |
| 85730 | 26 | | THROMBOPLASTIN TIME, PARTIAL | Pathology |
| 85730 | 26 | | THROMBOPLASTIN TIME, PARTIAL | Pathology |
| 85730 | 26 | | THROMBOPLASTIN TIME, PARTIAL | Pathology |
| 86850 | 26 | | RBC ANTIBODY SCREEN | Pathology |
| 86850 | 26 | | RBC ANTIBODY SCREEN | Pathology |
| 86900 | 26 | 91 | BLOOD TYPING, ABO | Pathology |
| 86900 | 26 | 91 | BLOOD TYPING, ABO | Pathology |
| 86901 | 26 | 91 | BLOOD TYPING, RH (D) | Pathology |
| 86901 | 26 | 91 | BLOOD TYPING, RH (D) | Pathology |
| 86923 | 26 | | Compatibility test, electric | Pathology |
| 86923 | 26 | | Compatibility test, electric | Pathology |
| 86965 | 26 | | POOLING BLOOD PLATELETS | Pathology |
| 86965 | 26 | | POOLING BLOOD PLATELETS | Pathology |
| 87040 | 26 | | BLOOD CULTURE FOR BACTERIA | Pathology |
| 87070 | 26 | | CULTURE SPECIMEN, BACTERIA | Pathology |
| 87070 | 26 | | CULTURE SPECIMEN, BACTERIA | Pathology |
| 87070 | 26 | | CULTURE SPECIMEN, BACTERIA | Pathology |
| 87075 | 26 | | CULTURE SPECIMEN, BACTERIA | Pathology |
| 87077 | 26 | | aerobic isolate, additional methods | Pathology |
| 87088 | 26 | | Urine bacteria culture | Pathology |
| 87102 | 26 | | FUNGUS ISOLATION CULTURE | Pathology |
| 87116 | 26 | | MYCOBACTERIA CULTURE | Pathology |
| 87186 | 26 | | ANTIBIOTIC SENSITIVITY, MIC | Pathology |
| 87205 | 26 | | SMEAR, STAIN, INTERPRET | Pathology |
| 87205 | 26 | | SMEAR, STAIN, INTERPRET | Pathology |
| 87205 | 26 | | SMEAR, STAIN, INTERPRET | Pathology |
| 87206 | 26 | | SMEAR, STAIN, INTERPRET | Pathology |
| 86891 | | | AUTOLOGOUS BLOOD, OP SALVAGE | Perfusion |
| 99190 | | | SPECIAL PUMP SERVICES | Perfusion |
| 99233 | | | SUBSEQUENT HOSPITAL CARE | Pulmonary/Critial Care |
| 99233 | | | SUBSEQUENT HOSPITAL CARE | Pulmonary/Critial Care |
| 99233 | | | SUBSEQUENT HOSPITAL CARE | Pulmonary/Critial Care |
| 99233 | | | SUBSEQUENT HOSPITAL CARE | Pulmonary/Critial Care |
| 99233 | | | SUBSEQUENT HOSPITAL CARE | Pulmonary/Critial Care |
| 99255 | | | INITIAL INPATIENT CONSULT | Pulmonary/Critial Care |
| 99291 | | | E/M CRITICAL CARE (FIRST HOUR) | Pulmonary/Critial Care |
| 70450 | 26 | | CAT SCAN OF HEAD OR BRAIN | Radiology |
| 70450 | 26 | | CAT SCAN OF HEAD OR BRAIN | Radiology |
| 70450 | 26 | | CAT SCAN OF HEAD OR BRAIN | Radiology |
| 70450 | 26 | | CAT SCAN OF HEAD OR BRAIN | Radiology |
| 70450 | 26 | | CAT SCAN OF HEAD OR BRAIN | Radiology |
| 71010 | 26 | | CHEST X-RAY | Radiology |
| 71010 | 26 | | CHEST X-RAY | Radiology |
| 71010 | 26 | | CHEST X-RAY | Radiology |
| 71010 | 26 | 77 | CHEST X-RAY | Radiology |
| 71010 | 26 | | CHEST X-RAY | Radiology |
| 71010 | 26 | | CHEST X-RAY | Radiology |
| 71010 | 26 | | CHEST X-RAY | Radiology |
| 71010 | 26 | | CHEST X-RAY | Radiology |
| 71010 | 26 | | CHEST X-RAY | Radiology |
| 71020 | 26 | | CHEST X-RAY | Radiology |

In certain embodiments, the disclosure comprises physicians and may comprise facilities within the group providing a beneficiary with services covered by one or more health care bundles. Fees for a health care bundle may be paid to a physician by an administrative entity, and the administrative entity may collect fees for the health care bundle from beneficiaries, secondary insurance carriers, employer groups, or other third party payers. The administrative entity may collect information on actual health care bundles for the database as described above, including diagnosis, surgical procedures, postoperative courses, medical history information, and personal demographic data.

The administrative entity may also receive global payments from beneficiaries, secondary insurance carriers, employer groups, or other third party payers for certain services, and may provide negotiated rates to same. The administrative entity may calculate the difference between the actual cost of services and the health care bundle fee. Where the costs of services are lower than the fee for the health care bundle, the difference or savings may be paid to or shared with the physicians and health care providers in the group. The difference will sometimes be paid by the administrative entity directly to the physicians and other healthcare providers in the group. Physicians and health care providers in the group may also receive additional payments for limiting medically unnecessary services or efficiently managing complications, meeting clinical goals set by the group, or providing services within the predetermined cost rate (cost efficiency).

The administrative entity may also verify beneficiary coverage with secondary carriers before authorizing the physicians and health care providers in the group to provide services. The administrative entity may monitor health care bundle services for consistency with secondary carrier coverage and manage denials of services where coverage is not consistent.

### Example 1

A system for administration of bundled health care pricing comprising software for bundled pricing which implements algorithms that carry out the following process steps:

a) Setting up a system for bundling, such as by defining one or more database fields that identify associated data structures for information on pricing, payments, providers, contracts, master and other codes for cases, packages, bundles or episodes, bundling rules, and length of stay (LOS) associated with particular episodes, cases, or packages.

b) receiving and storing information about a bundled case episode, such as by receiving a record identifier for a bundled case episode and associated record fields and storing the record fields in association with the record identifier;

c) generating a unique case identifier (ID) for the bundled case episode using a case identifier algorithm or in other suitable manners;

d) generating notification of the unique case ID to the providers who will provide services for the bundled case using a notification algorithm or in other suitable manners;

e) electronically receiving claims for services which are generated by providers, both facility and professional;

f) electronically identifying a specific claim using master procedural and diagnosis codes that identify a specific case rate or bundle price (previously set-up) and then automatically matching one or more other claims (as either inclusive to or excluded from the bundle) to the case ID of the identified bundled case;

g) electronically matching each claim associated with the bundled episode or case with length of stay (LOS) data to determine whether it is inclusive or exclusive of the length of stay for the bundled case rate;

h) electronically determining whether the case exceeds the fixed LOS for the identified bundle, package or episode as set-up in the database, and computing outlier provisions, if applicable;

i) automatically calculating the case rate for the bundled case, including any additional outlier billings, if applicable for accounts receivable (AR);

j) automatically calculating the accounts payable (AP) to providers on the case, both facility and professional;

k) automatically calculating net margin per case prior to potential risk pool claims;

l) electronically submitting the single, repriced bundled claim to a third party payer and/or other responsible party; and

m) automatically providing claim status to each provider on the case, through the system and internet, including but not limited to the following statuses: billed, in process, denied for more information required, or paid.

In this example, the system can also identify master procedural and diagnosis codes and automatically match claims with the case ID of the bundled case. The algorithms can cause a list of master codes and other codes that have previously been set up in the system to be accessed, such as to identify claims as they entered the system and determine whether they are associated with a specific case or not. Once a master code is identified, the case is created for the case ID, and the system matches one or more other claims coming in as either inclusive in the case or excluded from the case. If a claim is processed and the case ID is included on the claim from the provider, the system can simply match the claim to the case. If a case ID is not provided as the claim is entered by the provider, the system can search by patient name, dates of service, provider of care, diagnosis and procedure (or other combinations of variables) to determine whether the claim is associated with a particular case.

In step (d) above, healthcare providers in the group are contractually required to notify the administrative entity of cases they participate in, however, the administrative entity also has access to the facility system and surgery schedules to determine which healthcare provider participates in which case. Once a case ID has been established, the administrative entity notifies providers in three ways: (1) automatically via a portal through the internet, once a case is set up, (2) via facsimile and email, and (3) as a fail safe, the administrative entity assigns staff to call healthcare providers where no acknowledgement or claim on a case has been verified or received by the administrative entity.

### Example 2

A system for administration of bundled health care pricing comprising software operating on a processing platform which carries out the following process steps:
a) electronically receiving payment data from insurance companies, other third party payers and/or or individual patients;
b) electronically receiving and processing electronic funds transfer (EFT) or other forms of payment data, including an explanation of benefits (EOB) record that includes predefined data fields, and posting of payments on a case, which may include electronic, automatic posting;
c) electronically processing payment and providing EOB records to one or more providers on a case, which may include EFT and electronic EOB processing, based on rules set-up for the bundled case;
d) electronically calculating unpaid balances per contract rules;
e) electronically calculating and routing amounts subject to appeals or collections and processing additional payments to providers;
f) electronically linking or bundling one more potential, additional claims which are inclusive to the case and processing and paying additional payments from risk pool, if applicable, to such providers;
g) electronically determining a final net margin after risk data for a case/episode/package is computed; and
h) electronically determining a final net margin of one or more cases computed, such as at year end or other at other suitable periods, and distributing positive balance in the risk pool to providers, or requesting subscription from providers if a negative balance exists in the risk pool;
i) the system can utilize the database to electronically generate reports containing data that defines one or more parameters for prospective financial and clinical risk of cases, episodes, packages or bundles already processed.

### Example 3

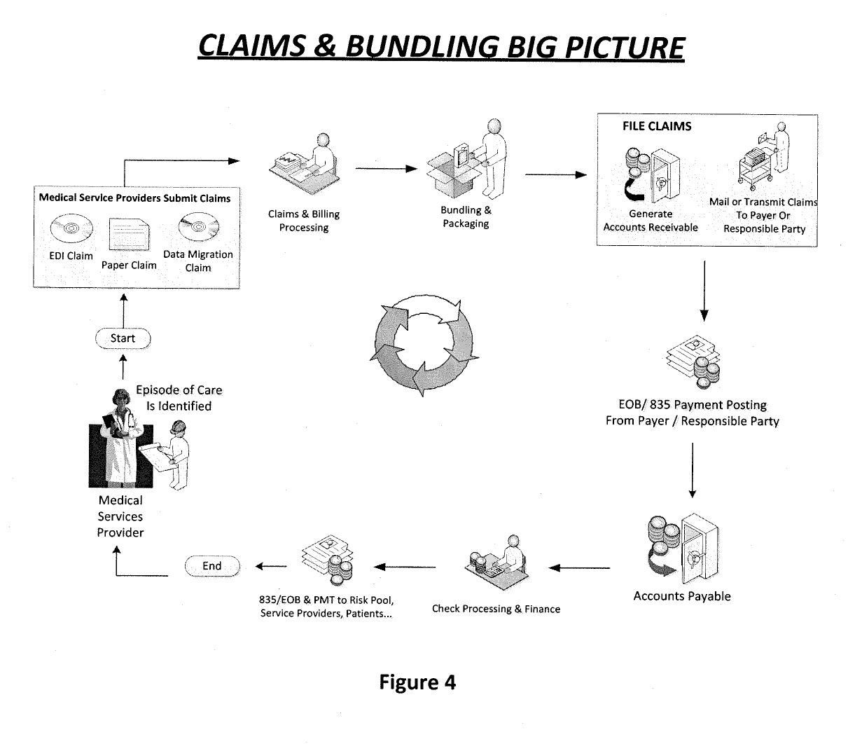

In one exemplary embodiment, the present disclosure comprises a bundled pricing and posting process, as shown in FIG. 4. The components of the bundling and posting process include one or more software systems operating on general purpose processing platforms, as further described herein. The bundled pricing and posting process starts with the rendering and billing of services from medical service providers.

After an episode of care is identified, an EDI claim containing a plurality of predefined data fields and a paper claim are submitted to a claims and billing processing system. The claim is then processed by a bundling and packaging system to generate accounts receivable, and an electronic record of the claim is transmitted to the payer or responsible party. An EOB/835 payment posting is received from the payer or responsible party, and the bundling and packaging system records that accounts payable data has been received. The EOB/835 payment is transmitted to a check processing and finance system, and an associated payment can be distributed to the risk pool, to service providers, to patients or to other suitable parties.

### Example 4

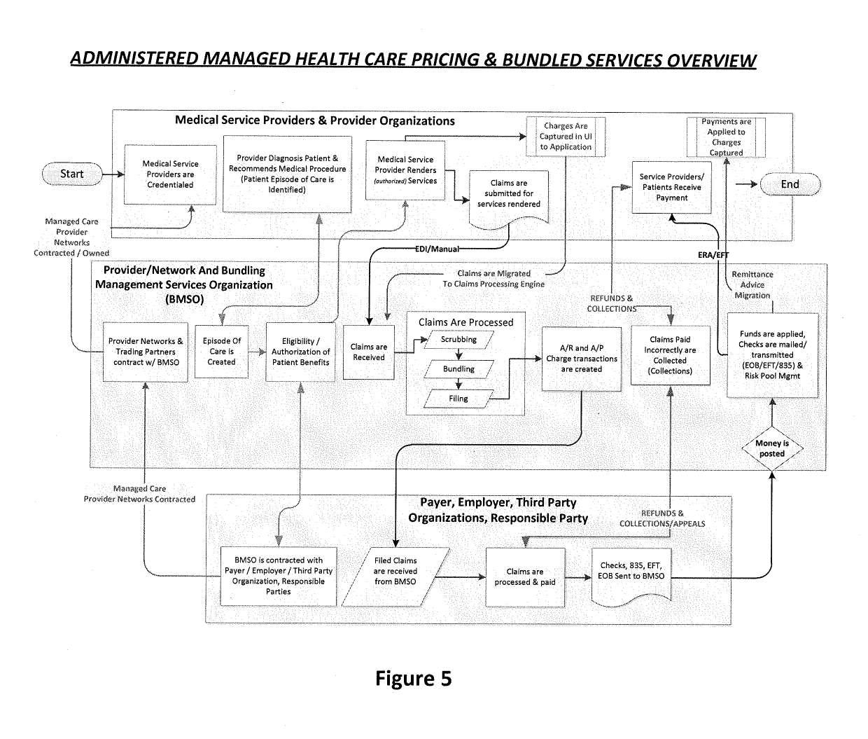

In another exemplary embodiment, the present disclosure comprises one or more software systems operated by medical service providers and provider organizations, which electronically interface with a provider/network and a Bundling Management Services Organization (BMSO), and a payer, employer, third party organization, or responsible party, as shown in FIG. 5.

### Example 5

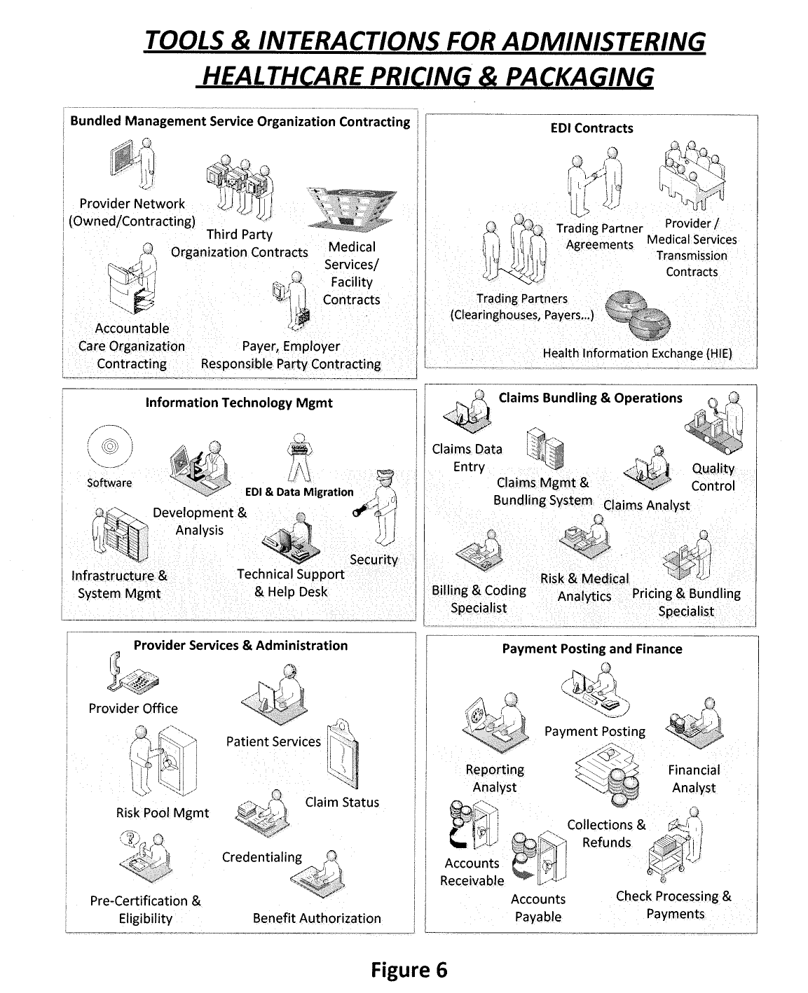

In another exemplary embodiment, the present disclosure comprises one or more software tools and defined electronic interactions for administering healthcare pricing and packaging, as shown in FIG. 6.

### Example 6

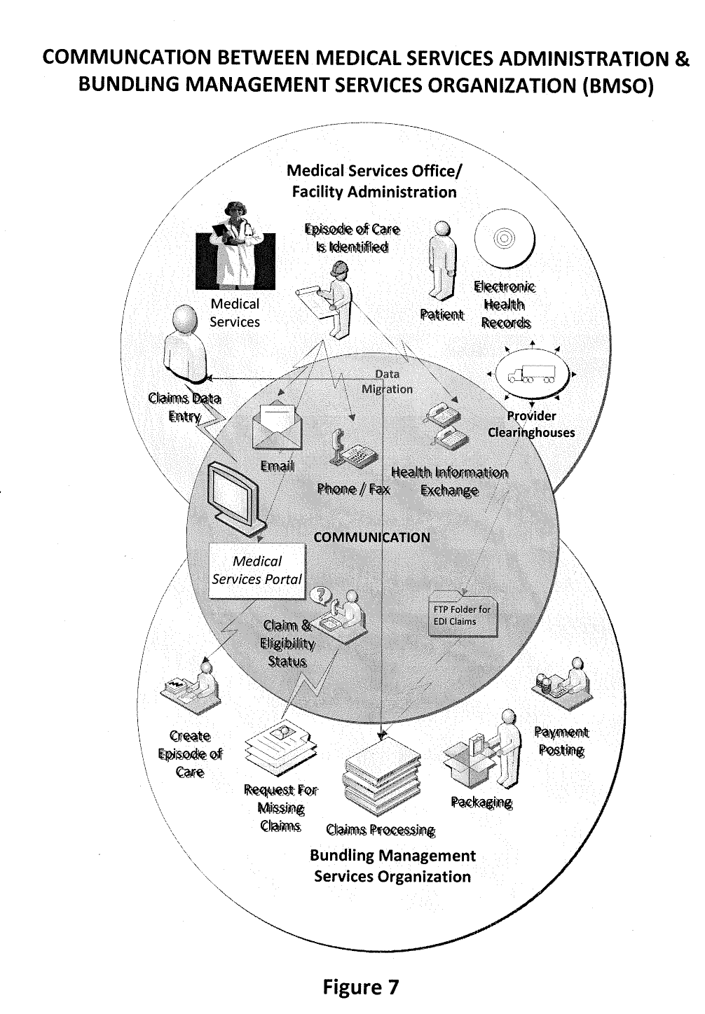

In another exemplary embodiment, the present disclosure comprises electronic communication methods and protocols for use between medical services office data processing systems and BMSO data processing systems, as shown in FIG. 7. Data relating to the claim, medical services associated with the claim, and patient information and electronic health records are communicated from the medical services office or facility to the BMSO data processing systems. The BMSO data processing systems create an episode of care data record, request missing claims data, processes claims, performs packaging, and posts payment.

### Example 7

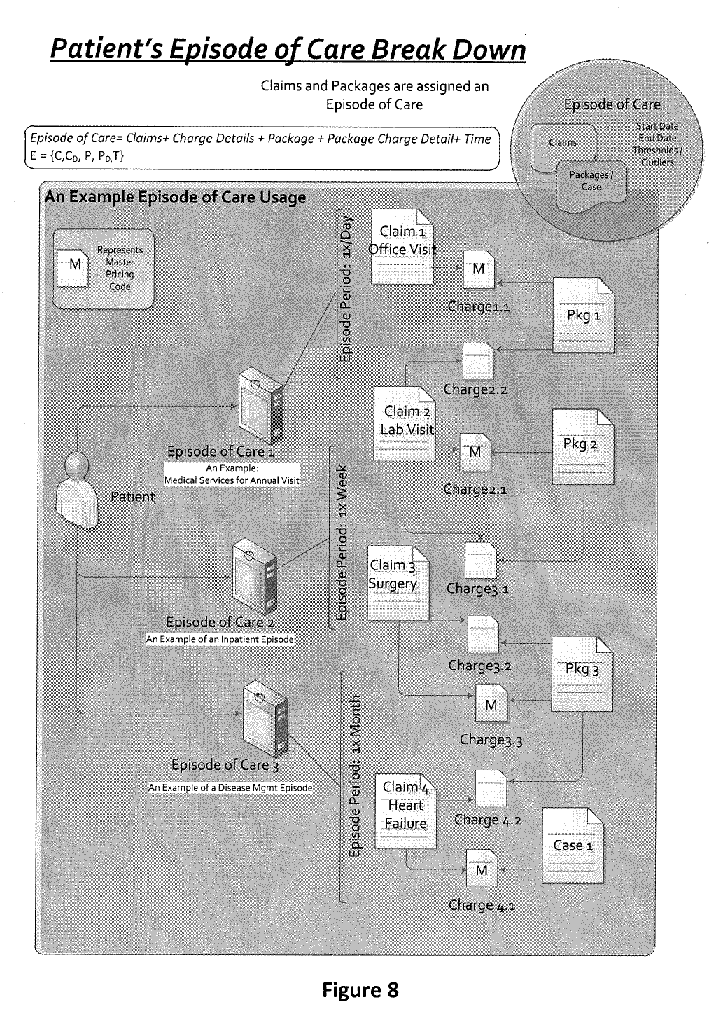

FIG. 8 shows several exemplary episodes of care that can be processed in accordance with exemplary embodiments of the present disclosure, including a medical services annual visit, an inpatient episode of care, and a disease management episode.

### Example 8

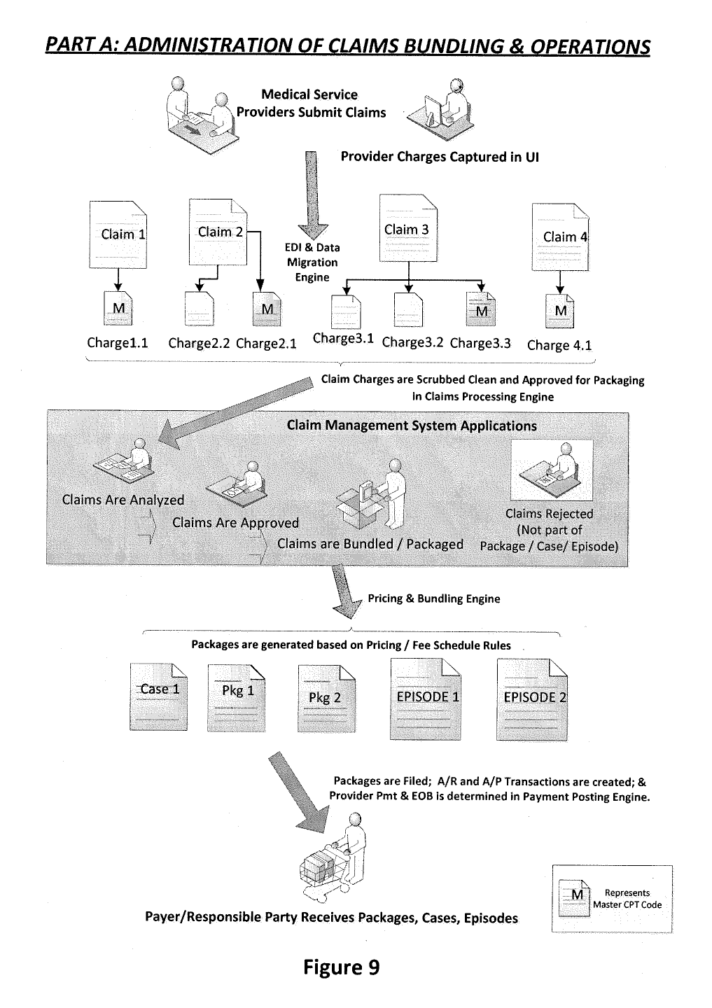

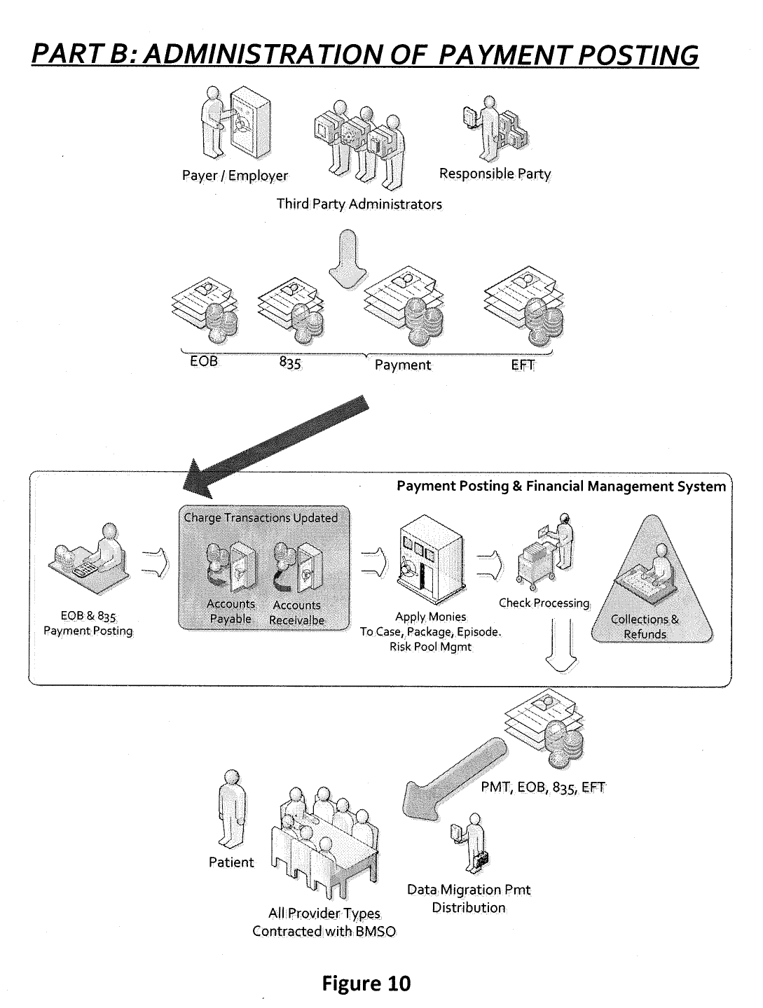

In another exemplary embodiment, the present disclosure comprises a hierarchy of claims system processes, as shown in FIG. 9. A medical service provider or providers electronically submit several related claims, which are then analyzed by claim management system applications and either approved or rejected. Claims can be bundled, and packages can be created based on pricing/fee schedule rules. The packages are filed, and accounts receivable and accounts payable transaction data is generated. Processing systems for the payer or responsible party then receive the package data, case data, and data defining the episodes for payment. In this embodiment, the disclosure further comprises a hierarchy of payment posting system processes, as shown in FIG. 10. Payers, employers, third party administrators, and/or responsible parties submit EOB. 835, payment, or EFT to a Payment Posting and Financial Management System, which can be one or more software applications that operate in a coordinated manner to process data, to generate user interfaces for review and entry of data, or for other suitable purposes. The Payment Posting and Financial Management System updates accounts payable and accounts receivable and applies payment data to the appropriate case, package, episode, or risk pool. Payment data is also transmitted to medical service providers and provider organizations.

### Example 9

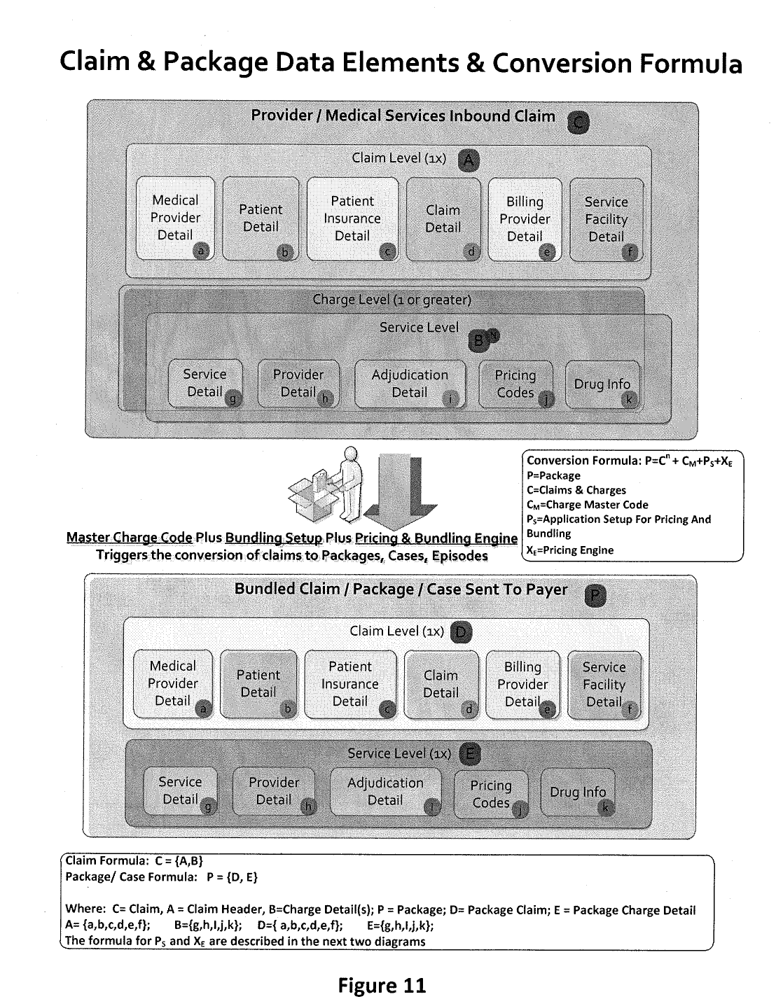

FIG. 11 shows the components of a submitted claim and transmitted package in an embodiment of the present disclosure. A pricing engine converts inbound claims from a medical service provider to a bundled claim, case, or episode to be sent to payer. In some embodiments, the conversion to a bundled claim can operate according to the following equation:

P=Cⁿ+Cₘ+Pₛ+X_{E}

Where P=package data; C^{N}=claim data and charge data; C_{M}=the charge master code; P_{S}=application setup for pricing and bundling data; X_{E}=pricing engine data.
In some embodiments, the bundled claim to be sent to a payer is expressed according to the following equation:

C={A,B}

Where C=claim data; A=claim header data; B=charge detail data.
The claim header (A) is comprised of one or more of: medical provider detail data, patient detail data, patient insurance detail data, claim detail data, billing provider detail data, and service facility detail data.
The charge detail data (B) is comprised of one or more of: service detail data, provider detail data, adjudication detail data, pricing code data, and drug data.
The package claim data (D) is comprised of one or more of: medical provider detail data, patient detail data, patient insurance detail data, claim detail data, billing provider detail data, and service facility detail data.
The package charge detail data (E) is comprised of one or more of: service detail data, provider detail data, adjudication detail data, pricing code data, and drug data.

### Example 10

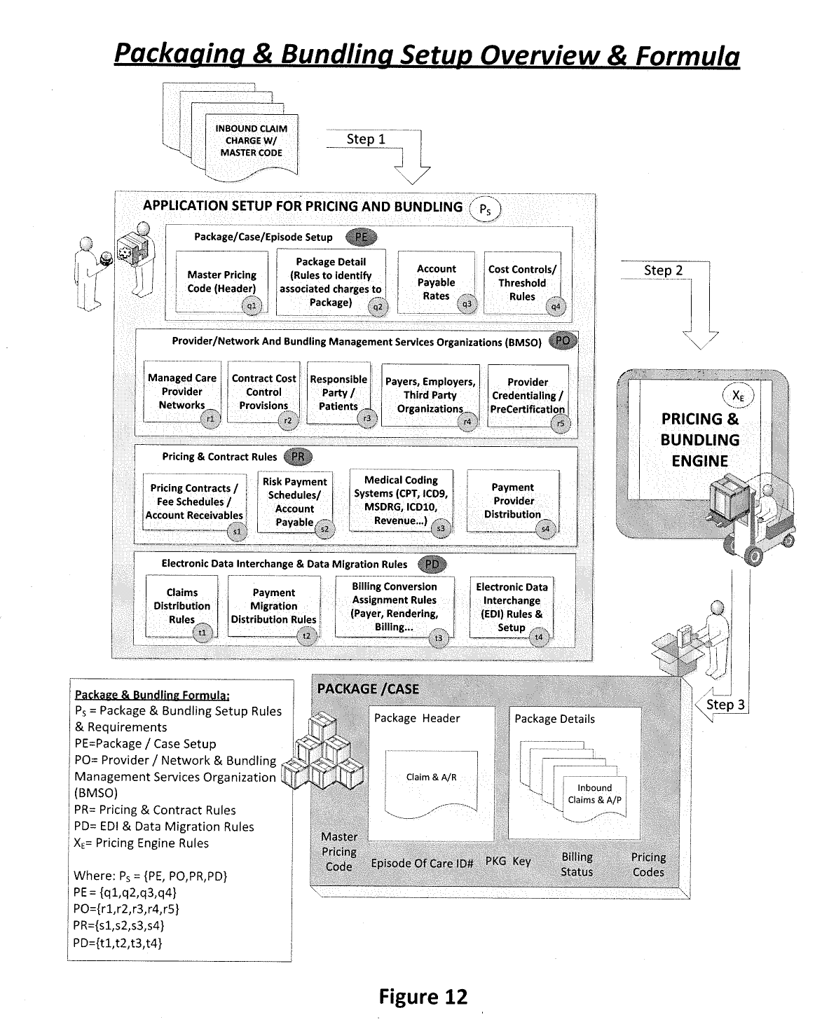

FIG. 12 shows package and bundling rules and requirements for an embodiment of the present disclosure.

In some embodiments of the present disclosure, the package and bundling setup rules and requirements can be a function of package/case setup data (PE), provider/BMSO data (PO); pricing and contract rules data (PR); EDI data and data migration rules (PD); pricing engine rules data (X_{E}), and follows:

Ps={PE,PO,PR,PD}

PE is a function of the Master Pricing Code (q1), Package Detail (q2), Account Payable Rates (q3) and Cost Controls/Threshold Rules (q4).
PO is a function of Managed Care Provider Networks (r1), Contract Cost Control Provisions (r2), Responsible Party/Patients (r3), Payers, Employers, Third Party Organizations (r4), and Provider Credentialing/Pre-certification (r5).
PR is a function of Pricing Contracts/Fee Schedules/Account Receivables (s1), Risk Payment Schedules/Account Payable (s2), Medical Coding Systems (s3), and Payment Provider Distribution (s4).
PD is a function of Claims Distribution Rules Op, Payment Migration Distribution Rules (t2), Billing Conversion Assignment Rules (t3), Electronic Data Interchange Rules and Setup (t4).

### Example 11

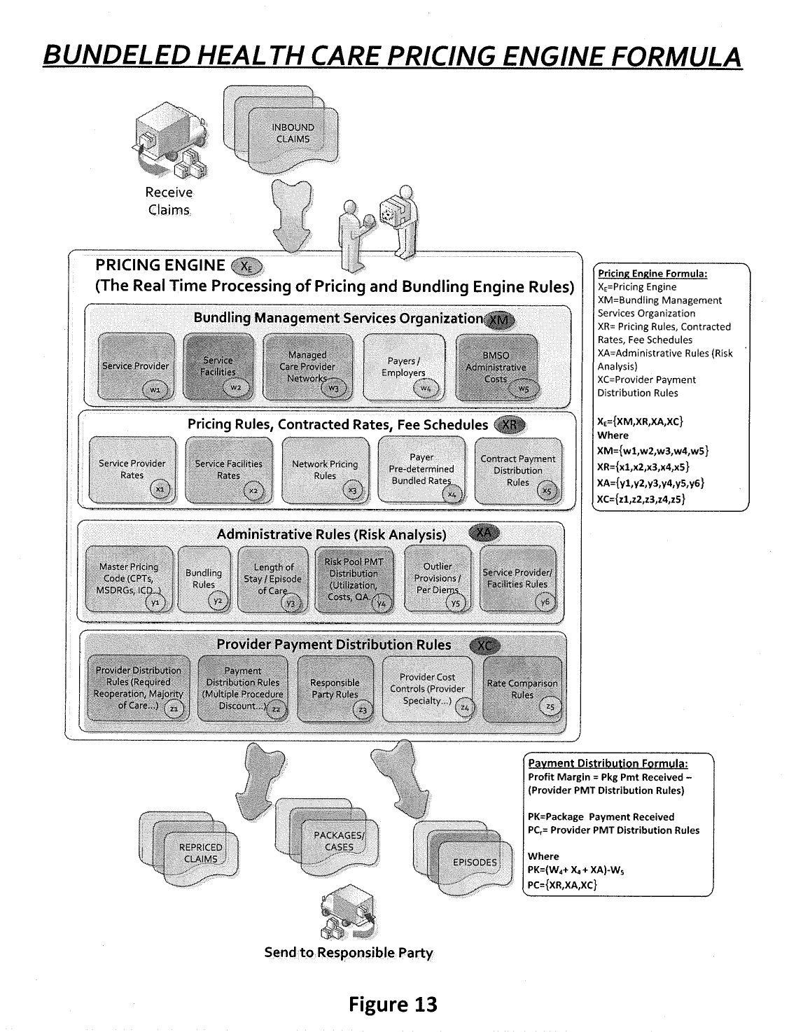

In another embodiment, the present disclosure comprises a pricing engine algorithm, as shown in FIG. 13. The pricing engine data (X_{E}) is a function of the BMSO data (XM), pricing rules, contracted rate data, fee schedule data (XR), administrative rules (XA), and provider payment distribution rules (XC):

X_{E}={XM,XR,XA,XC}

Where XM is a function of Service Provider (w1), Service Facilities (w2), Managed Care Provider Networks (w3), Payers Employers (w4), BMSO Administrative Costs (w5).
Where XR is a function of Service Provider Rates (x1), Service Facilities Rates (x2), Network Pricing Rules (x3). Payer Pre-Determined Bundled Rates (x4), Contract Payment Distribution Rules (x5).
XA is a function of Master Pricing Code (y1), Bundling rules (y2), Length of Stay/Episode of Care (y3), Risk Pool PMT Distribution (y4), Outlier Provisions/Per Diems (y5), and Service Provider Facilities Rules (y6).
XC is a function of Provider Distribution Rules (z1), Payment Distribution Rules (z2), Responsible Party Rules (z3), Provider Cost Controls (z4), Rate Comparison Rules (z5).

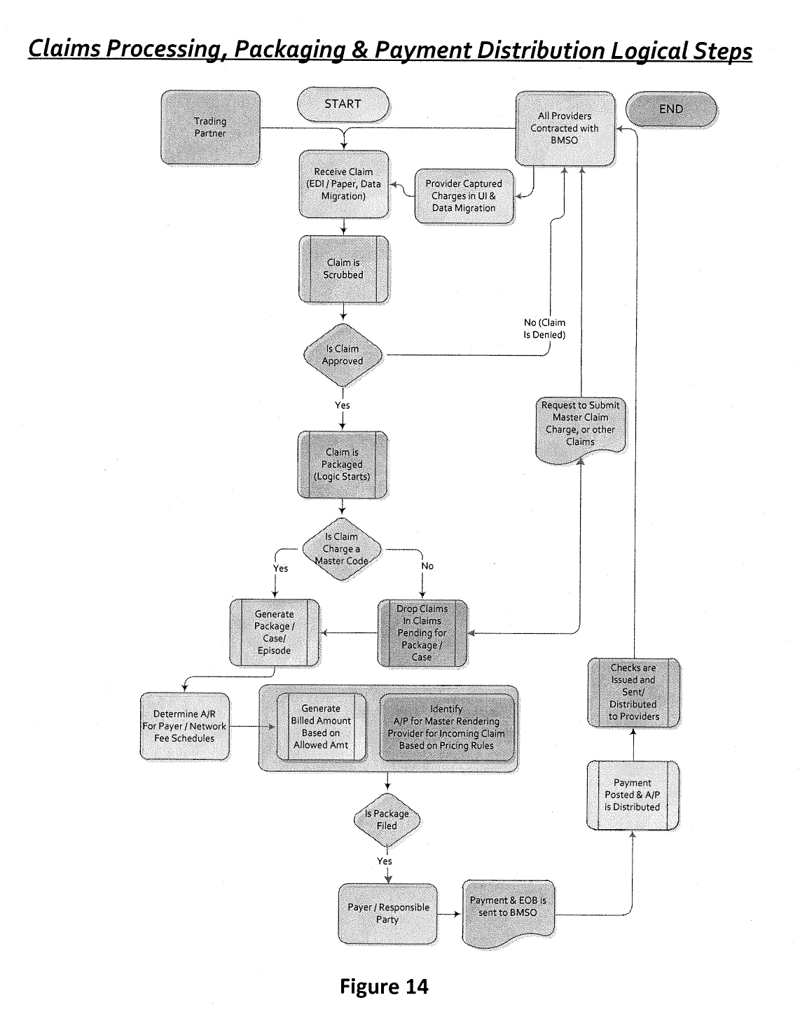

FIG. 14 shows how a claim is transformed into a bundled package or case, according to an embodiment of the present disclosure.

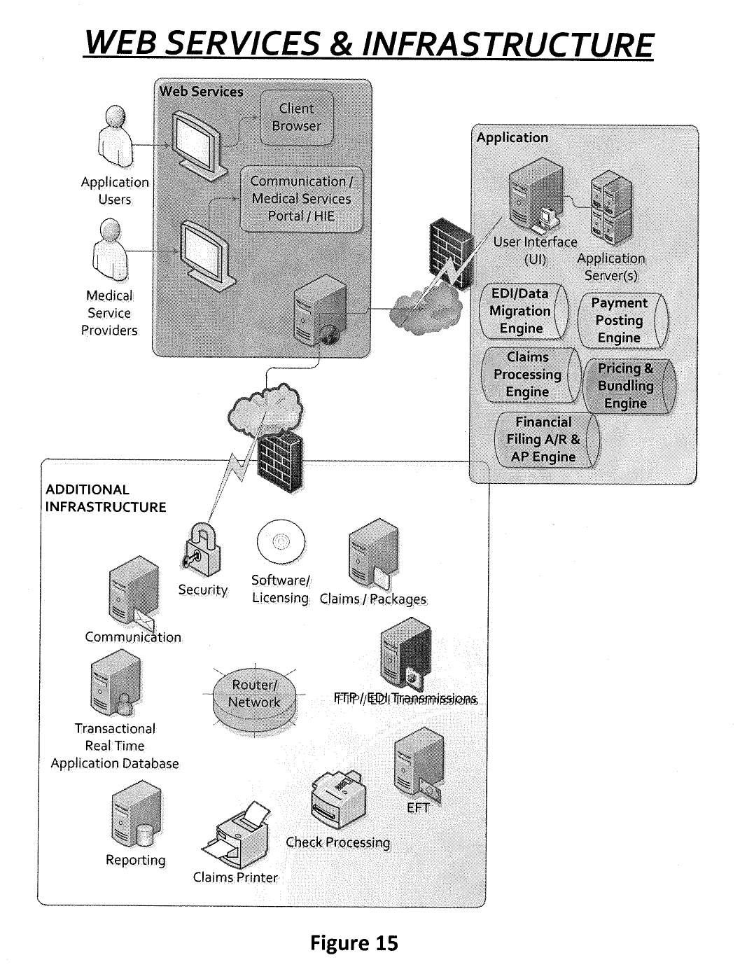

FIG. 15 shows web services and infrastructure which are associated with an embodiment of the present disclosure.

### Example 13

Case Study:

Package Type: AortoCoronary Bypass (ACB), Episode of Care: Bypass/ACB

This example describes the analysis and breakdown of the ACB bundled package and compares it to a distribution based on a fee-for-service (FFS) model of payments to providers. This case study provides an example of a bundling and pricing methodology that can be used by BMSO systems for comparing the cost savings to a FFS payer claims processing and payment model. Through bundled services fee contracts with providers and payers, the BMSO and providers, through shared risk, are able to administer and control costs more efficiently, as will be further described herein.

This example describes the assignment of provider charges to an ACB Package, the creation of the ACB package and the distribution of payment for the ACB Package across the provider charges. The following key points are described in greater detail below:
The process of assigning an Episode of Care (EPC) or Case in a specific period of time. This includes the pre-determined, fixed fees for a bundled packaged and the determination of outliers in an episode.
The process of administering and assembling individual incoming provider claims and assigning them to the ACB Package
The process and rules of generating and pricing an ACB Package.
The process of receiving and posting payments from Payer against the ACB Package
The process and rules of payment distribution for ACB Package to Providers after the payment is received from the payer

### Overview of ACB Package and ACB Episode of Care

An Episode of Care describes the beginning through the end of the patient's medical episode. The ACB episode described in this document had 92 charges submitted by the providers for services rendered to the Patient. Of those 92 charges, 2 were identified as master codes which trigger the creation of packages in the BMSO application. Due to the outlier threshold contract provisions setup for this episode, 5 additional packages were created after the medical services provided exceeded the contracted Length of Stay (LOS). Below is a summary breakdown of the ACB Episode of Care which also shows a comparison of how a payer, under a traditional FFS model, would have paid an additional $4,988.00 for processing these same provider's claims. This ACB episode also shows a net margin to the shared risk pool of about $105, a nominal but positive amount for a complicated case.

Bypass Episode of Care Breakdown
Total # of Provider Claim Charges Submitted: 92
Gross Provider Charges Submitted for charge details: $32,185.00
Total # of Packages created for Episode: 7 Packages
Total Amount Paid for Packages in Episode from Payer for BMSO: $8,515.00
Total Amount Distributed to Providers: $8,410.00
Total Profit Margin for Episode: $105.00
Total Amount that would have been paid on FFS basis by Payer to Providers: $13,095.13
Bundled Cost Savings to payer: $4,988

A. Episode of Care Assignment & Package Fee Contracts

An Episode of Care is defined as one or more of the associated or assigned claims and charge details that are sent by providers, including the packages and package charge detail across a period of time. The Episode of Care can be described as Claims+Claim Charges+Package+Package Charges+Time, using the following equation:

E={C,C_{D},P,P_{D},T}

### Where: E=Episode of Care; A=Claim; B=Charge; D=Package Claim; E=Package Charge; T=Time

The process of assigning an Episode of Care (EPC) or Case requires the inter-communication between the contracted providers and the BMSO. As shown in FIG. 7, communication methods can vary based on provider preference or technology available to them and the BMSO, such as phone and associated data entry through a graphic user interface, fax, email, a provider portal or other suitable systems. The BMSO receives the provider case information, including patient name, diagnosis, provider, diagnosis start date and possibly diagnosis end date. An episode of care (EPC) identification number is generated by the system to allow the claims submitted to be tagged to the correct Episode. This identification number is then communicated back to the provider office by the BMSO system and the providers include this EPC during the submission of their claim.

In this example of an ACB Episode there were seven packages generated based on the master codes identified in the system. These master charge codes are the triggers to generate the packages as defined in the system. The contracted fees or the total A/R (accounts receivable) is the contracted amount negotiated with the payer for each package. The length of stay outlier threshold days are also negotiated as part of each package as described in Chart 1 below. In this episode, the system determined that the ACB package dates of services exceeded the payer contracted outlier threshold length of stay for this package of 8 days, and thus five outlier packages were created (ACB Per Diems) with the master code of 99233. Provider claims for this episode were received from the period of December 5^{th} to December 18^{th}. The package rules states that for every day an ACB package detail charge is received, a new outlier package will be created if it exceeds the LOS. This contractual term serves as minimal re-insurance to cover costs should complications occur. Charges on the last DOS date of the episode are not included in the generation of outlier packages. Therefore only five packages were created as described below.

In addition to LOS, other outlier parameters can be used to generate a new outlier package, such as exceeding a total dollar amount for the EPC, exceeding a total number of related services for the EPC, or other suitable variables. In this exemplary embodiment, if the total dollar amount for the EPC exceeds a ceiling, a new outlier package can be created. Additional outlier packages can also or alternatively be created for additional levels above the ceiling, such as for every additional amount that is equal to a fixed predetermined amount, a variable predetermined amount, or in other suitable manners. Likewise, additional related services associated with the EPC, such as rehabilitation visits, may include a first fixed amount (such as ten visits), with additional outlier packages for additional amounts (such as one additional outlier package for each additional visit, for each ten additional visits, a first outlier package for the first five additional visits and one additional outlier package for each additional visit beyond five additional visits, or other suitable algorithms).

The ACB Episode of Care is described in Chart 1. There are 7 packages created with the set fees totaling $8.515.00 which is the contracted accounts receivable expected from the contracted payer for the bundled episode. When compared to $13,503, which is what a payer would have paid on a FFS basis, this is an increase in cost of $4,988 or 58% more. This embodiment of the present disclosure is designed to process and compute these comparisons.

CHART 1
Packages Assigned to this Episode:

| | | | | | | | Gross | | | |
|---|---|---|---|---|---|---|---|---|---|---|
| | | Master | Charges | | | | Provider | | | |
| Packages | Start Date | Code | Attached | Total A/P | Total A/R | Margin | Charges | FFS Payer Pmt LOS | Pkg Key | |
| ACB | Dec. 5, 2008 | 33533 | 85 | $8,150.00 | $8,000.00 | ($150.00) | $32,135.00 | $13,485.00 | 8 | 101 |
| EKG1 | Dec. 5, 2008 | 93010 | 1 | $10.00 | $15.00 | $5.00 | $50.00 | $18.00 | 1 | 102 |
| ACB Per Diem | Dec. 13, 2008 | 99233 | 1 | $50.00 | $100.00 | $50.00 | $0.00 | $0.00 | 1 | 103 |
| ACB Per Diem | Dec. 14, 2008 | 99233 | 1 | $50.00 | $100.00 | $50.00 | $0.00 | $0.00 | 1 | 104 |
| ACB Per Diem | Dec. 15, 2008 | 99233 | 1 | $50.00 | $100.00 | $50.00 | $0.00 | $0.00 | 1 | 105 |
| ACB Per Diem | Dec. 17, 2008 | 99233 | 1 | $50.00 | $100.00 | $50.00 | $0.00 | $0.00 | 1 | 106 |
| ACB Per Diem | Dec. 18, 2008 | 99233 | 2 | $50.00 | $100.00 | $50.00 | $0.00 | $0.00 | 1 | 107 |
| | | | 92 | $8,410.00 | $8,515.00 | $105.00 | $32,185.00 | $13,503.00 | | |

B. Administration of Provider Claims

In this embodiment of the disclosure, the process of administering and assembling of individual incoming provider claims and assigning them to the ACB Package includes the following steps:

1. Receiving and storing individual incoming provider claims

2. Identifying if a master code is assigned to an incoming provider claim

3. If a master code is identified, then generate a package associated to this master code

4. The system will determine and identify claims that belong to the package

In this embodiment, provider claims are submitted and received using various options. Providers using the BMSO's practice management system will enter their claims via the application user interface. These claims will be saved and stored in the practice management application and migrated to the claims processing application by migrating internal data fields. Other providers will submit their claims electronically to contracted clearinghouses that will in turn send the claims electronically using the HIPAA compliant Electronic Data Interchange (EDI) format. If the external data fields contained within these claims pass loading and scrubbing logic, they will be saved and stored in claims processing application. Part of the loading logic determines if a claim is submitted by contracted providers versus non-contracted providers, and the scrubbing logic determines if the claim has all data element components required for processing in the pricing and bundling processing engine. As a last resort some providers may send claims via paper which are then manually entered into the claims processing engine through a user interface.

Once submitted provider claims are stored in the claims processing engine with no issues, they move to processing in the pricing and bundling engine, where claims are separated into two groups: 1) claim charge details identified as having a master charge code according to application set-up, and 2) claim charge details that do not have a claim master charge code. Master charge codes identify bundle packages in accordance with set-up rules. Those claims in group 2 are sent to claims pending for package until the master charge detail is identified and the package is created. Once the package is created, these charge detail are automatically assigned based on set-up rules to a package and are identified as the package charge details. Package charge details will be assigned to a package based on the episode of care identifier (as described earlier), patient demographic data, and dates of services rendered. Outlier variables such as LOS and other threshold requirements in the set-up rules then determine if remaining charge detail are required to be bundled into outlier packages within the episode of care. The system will separate and process these accordingly.

As described in FIG. 11, all data elements in a claim and a claim charge detail are critical for the identification of a master code charge detail. These include the identification of the payer who will pay the package; the billing provider and rendering providers contracted with the BMSO and the provider designated specialties among others. All medical codes submitted, including but not limited to Medicare Severity Diagnosis Related Groups (MSDRG) codes, revenue codes, Current Procedural Terminology (CPT) codes, International Statistical Classification of Diseases and Related Health Problems codes (ICD9, ICD10), Healthcare Common Procedure Coding System (HCPCS) codes, or other suitable codes contained in the charge details are also used to identify whether the charge is a master charge code and also how the pricing will be impacted when the package payment is posted in accounts receivable, which then affects accounts payable. The data elements for a package are derived based on the incoming provider claim and master charge detail that was used to trigger the generation of the package. The difference between a claim charge detail and master charge detail is the medical code(s) submitted in the claim. This medical code (e.g. CPT code, revenue codes) is the contracted code used by the payer and BMSO to define the package, the pre-determined contract package fee, and additional variables (e.g. length of stay, place of service) that make up the package/case contract between both entities. The payer and BMSO contract also defines what data elements will be sent in the package that will allow the payer to identify the package claim and package charge when it is transmitted to the payer. When the package is sent to the payer, the payer will be able to correctly identify the package and send the payment check with the correct package fee.

Therefore the claim and package formula is also important to determine what are the data elements that belong to a claim and package and can be described by the following equation or other suitable equations:

C={A,B};Package/Case Formula:P={D,E}.

### Where: C=Claim, A=Claim Header, B=Charge Detail(s); P=Package; D=Package Claim; E=Package Charge Detail

### ACB Package Generation

In this episode the ACB charge with the CPT Code of 33533 was identified as the Master Code to generate the primary package. The primary package was created using this master code and was also the master code that can be sent in the package charge detail to the payer.

The ACB package discussed in this case study, is described in detail using Chart 2 and Chart 3 below. Chart 2 below describes claim charge details that were submitted on December 5^{th} from the Cardiovascular Surgery Specialists. The system identified Charge 33533 as a master code for the ACB Package which generated an ACB Package with a package fee to a contracted payer of $8000 pursuant to Chart 1, Total AR. Once the AR is created and package billed to the payer, the system automatically calculates the A/P for each provider on a fixed, at risk payable schedule. This can be adjusted once actual payment is received from the payer. For the cardiovascular surgery specialty in Chart 2 below, the AP amount created is $3,800 which is the provider contracted fixed payment for this charge. One or more other charges that are associated to this package will be assigned as the package charge details but will not be paid.

CHART 2
Cardiovascular Surgery Charge Detail Provider Payment Breakdown

| | | | | | Payer |
|---|---|---|---|---|---|
| | INCURD_DT | HCPCS | BILLED | A/P | Pmt |
| CV | Dec. 5, 2008 | 15430 | $1,250.00 | $0.00 | $400.00 |
| Sur- | Dec. 5, 2008 | 20926 | $1,000.00 | $0.00 | $380.00 |
| gery- | Dec. 5, 2008 | 33508 | $40.00 | $0.00 | $15.00 |
| 582 | Dec. 5, 2008 | 33518 | $1,200.00 | $0.00 | $425.00 |
| | Dec. 5, 2008 | 33533 | $6,300.00 | $3,800.00 | $2,000.00 |
| | Dec. 5, 2008 | 33999 | $1,000.00 | $0.00 | $450.00 |
| | Dec. 12, 2008 | 32650 | $1,750.00 | $0.00 | $0.00 |
| | Dec. 12, 2008 | 32650 | $450.00 | $0.00 | $0.00 |
| | Dec. 12, 2008 | 32652 | $3,800.00 | $0.00 | $1,400.00 |
| | Dec. 12, 2008 | 32652 | $950.00 | $0.00 | $250.00 |
| | | | $17,740.00 | $3,800.00 | $5,320.00 |

After the master code and master specialty have been determined and the package has been created, the system can prepare for the receipt of charge detail from one or more other associated specialties involved in the episode of care. Chart 3 below describes the breakdown of the package by specialty, the number of charges associated with each specialty, the total billed amounts by each specialty, the total AP amounts which will be distributed each provider of each specialty, and lastly, the comparison of what a payer would have paid for this same specialty on a traditional FFS basis.

CHART 3
Package ACB - Breakdown of Charges Submitted by Provider Specialty

| Spc Code | Specialty | Start Date | End Date | # of Charges | Total Billed | A/P Amt | Payer Pmt |
|---|---|---|---|---|---|---|---|
| 579 | Cardiology | Dec. 5, 2008 | Dec. 5, 2008 | 3 | $2,170.00 | $500.00 | $1,035.00 |
| 580, 613 | Anesthesiology | Dec. 5, 2008 | Dec. 12, 2008 | 3 | $6,300.00 | $1,750.00 | $3,700.00 |
| 582 (M) | Cardiovascular | Dec. 5, 2008 | Dec. 12, 2008 | 10 | $17,740.00 | $3,800.00 | $5,320.00 |
| | Surgery | | | | | | |
| 587 | Pathology | Dec. 3, 2008 | Dec. 9, 2008 | 46 | $1,590.00 | $250.00 | $480.00 |
| 589 | Radiology | Dec. 5, 2008 | Dec. 14, 2008 | 11 | $595.00 | $145.00 | $210.00 |
| 602 | Internal | Dec. 9, 2008 | Dec. 18, 2008 | 4 | $1,645,00 | $500.00 | $1,360.00 |
| | Medicine | | | | | | |
| 588 | Pulmonary | Dec. 5, 2008 | Dec. 15, 2008 | 8 | $2,095.00 | $1,205.00 | $1,380.00 |
| | | | | 85 | $32,135.00 | $8,150.00 | $13,485.00 |

A. Receive Payment & Distribution of Payment to Providers

After the package is generated, the package is approved and filed in the BMSO financial real time processing engine. As described above, when the package is filed to the payer, the financial real time processing engine creates the accounts receivable and accounts payable charge transactions based on the application setup for pricing and bundling. The account receivable charge transactions are created for the package based on the package bundled fee contracted with the payer. In addition the accounts payable transactions are created for each specialty provider's submitted charges attached to the package, based on the provider contracted bundled rates. This section describes the distribution of payments for the ACB Package to the providers after the payment is received from the payer. The following steps are described:
1. Receiving payments from payer and post the payment (835, EFT, other).
2. Determining the distribution of payment to provider submitted charges
3. Applying the payment distribution against a provider's Explanation of Benefits (EOB) or Remittance Advice for the provider submitted charges
4. For the migrated submitted charges from our contracted providers, the payment is further distributed and posted against the open accounts receivable charge transactions

Payments from payers can be received by paper and entered for processing using a user interface, received electronically via the EDI 835 HIPAA transaction, received using electronic funds transfer bank transaction data, or in other suitable mariners. The EDI payment format is processed using the EDI engine which uses mapping logic to map from the EDI standard format to the BMSO payment posting format, and which loads the data to the payment and posting application. Once the payment data is loaded into the system, based on payer and charge transaction data, such as patient, claim and provider information, the payment is posted against the open accounts receivable charge transactions. As the accounts receivable charge transactions are updated against the package that was billed to the payer, the accounts payable transactions are then recalculated based on the package payment and updated to reflect any adjustments required for the package charge details. For the ACB package the accounts payable is broken down by rendering provider specialty for the submitted charges to describe the distribution of provider payments.

### ACB Package Provider Payment Distribution by Specialty

The following is an exemplary provider payment breakdown for the ACB package example in this case study. For cardiovascular surgery, the provider payment was a fixed payment of $3800 which is applied to the master code charge detail submitted by the provider, since this is the charge that triggers the creation of the ACB package. Chart 2 above further describes total submitted gross charges for the cardiovascular specialty. It is also important to note in this case study example that a reoperation due to complications occurred. This charge detail is listed and attached to the same package on the date of service of December 12. Due to contract terms and bundling rules in the system, complications and required reoperations during the stated length of stay are still included in the package and the payment to the cardiovascular surgery specialty is adjusted or increased. In this exemplary embodiment, the same fixed payment of $3,800 resulted, which is the contract risk assumed by the provider. This is one of the unique bundling rules utilized under episodes of care which translates into cost savings to a payer, who under an FFS model would be required to pay for these additional services. The provider charges submitted for the anesthesia specialty also reflect how bundled rates are controlled and contracted between the provider, the BMSO and payer. Under a bundled arrangement in the shared risk model, anesthesia is no longer paid for total operating room time spent. Anesthesia receives a fixed payment regardless of the time and/or complications. This promotes surgery and anesthesia working closely together as a team to increase efficiency while maintaining high quality. The fixed payment of $1700 was applied against the main anesthesia charge for the ACB package. The anesthesia consultant fee was paid at another rate based on anesthesia consultant setup. But the anesthesia charge on December 12 was not paid due to the required reoperation as described above. This is the shared risk model as processed by the system and built in unique rules surrounding the episode of care.

CHART 4
Anesthesia Charge Detail Provider Payment Breakdown

| | INCURD_DT | HCPCS | BILLED | A/P | Payer Pmt |
|---|---|---|---|---|---|
| Anesthe- | Dec. 12, 2008 | 00542 | $2,300.00 | $0.00 | $1,350.00 |
| siology/ | Dec. 5, 2008 | 00562 | $3,700.00 | $1,700.00 | $2,300.00 |
| Anesthe- | Dec. 5, 2008 | 36620 | $300.00 | $50.00 | $50.00 |
| siology | | | | | |
| Con- | | | | | |
| sultants | | | | | |
| (580, 613) | | | | | |
| | | | $6,300.00 | $1,750.00 | $3,700.00 |

Another unique process in some embodiments of the present disclosure is a rule and algorithm called Majority of Care (MOC). This rule can be utilized to prevent the churning of billing of similar FFS services by similar providers across multiple specialties for the same patient during the stated length of stay of the episode of care. The concept is to reduce cost through shared risk among providers during the episode. The MOC rule reflects how the BMSO manages and shares risk with their contracted providers when providers perform specific similar medical services on the same patient during a specific episode. Under bundling, there is only a set amount which is available for certain services, and they must be split accordingly. The MOC rule applies a process of splitting provider payments across multiple providers in the same package. In this ACB package the fixed payment of $1000 was split between the two provider specialties against the charges submitted by the cardiologist and internal medicine specialist on the same package during the same episode, which resulted in $1,392 less than what the payer would have paid for the same submitted provider charges on a FFS basis. Chart 5 and 6 describe the provider payment breakdown for these two specialties in more detail.

CHART 5
Cardiology Charge Detail Provider Payment Breakdown

| | INCURD_DT | HCPCS | BILLED | A/P | Payer Pmt |
|---|---|---|---|---|---|
| Cardiology- | Dec. 5, 2008 | 99232 | $1,500.00 | $500.00 | $750.00 |
| 579 | Dec. 5, 2008 | 99233 | $360.00 | $0.00 | $125.00 |
| | Dec. 5, 2008 | 99254 | $310.00 | $0.00 | $160.00 |
| | | | $2,170.00 | $500.00 | $1,035.00 |

CHART 6
Internal Medicine Charge Detail Provider Payment Breakdown

| | INCURD_DT | HCPCS | BILLED | A/P | Payer Pmt |
|---|---|---|---|---|---|
| Internal | Dec. 9, 2008 | 99232 | $75.00 | $0 | $75.00 |
| Medicine- | Dec. 9, 2008 | 99233 | $1,350.00 | $500.00 | $1,125.00 |
| 602 | Dec. 9, 2008 | 99254 | $220.00 | $0.00 | $160.00 |
| | | | $1,645.00 | $500.00 | $1360.00 |

The pulmonary specialist as shown in Chart 7 is only called in by the surgeon should the need arise. Since the surgeon directs whether this service is needed or not, the BMSO arranges for a negotiated fee-for-service contract on that basis and the expense of such a consultant is deducted from the shared risk pool. The AP in this example is less than the cost of what a payer would have paid on its FFS basis. The pathology specialist as shown in Chart 8 submitted 46 clinical pathology charges which are paid at a negotiated fixed payment of $250, regardless of the number of services provided. The radiology specialty as shown in Chart 9 below is also called into a case as needed by the surgeon, and the BMSO has contracted radiology specific payable rates. Again, these types of consultant expenses are deducted from the shared risk pool.

CHART 7
Pulmonary Charge Detail Provider Payment Breakdown

| | INCURD_DT | HCPCS | BILLED | A/P | Payer Pmt |
|---|---|---|---|---|---|
| Pulmo- | Dec. 15, 2008 | 99232 | $440.00 | $280.00 | $300.00 |
| nary- | Dec. 9, 2008 | 99232 | $110.00 | $70.00 | $75.00 |
| 588 | Dec. 11, 2008 | 99232 | $220.00 | $140.00 | $150.00 |
| | Dec. 5, 2008 | 99233 | $185.00 | $100.00 | $125.00 |
| | Dec. 6, 2008 | 99233 | $370.00 | $200.00 | $250.00 |
| | Dec. 9, 2008 | 99233 | $185.00 | $100.00 | $125.00 |
| | Dec. 11, 2008 | 99233 | $185.00 | $100.00 | $125.00 |
| | Dec. 5, 2008 | 99291 | $400.00 | $215.00 | $230.00 |
| | | | $2,095.00 | $1,205.00 | $1,380.00 |

CHART 8
Pathology Charge Detail Provider Payment Breakdown

| | INCURD_DT | HCPCS | BILLED | A/P | Payer Pmt |
|---|---|---|---|---|---|
| Pathology- | Dec. 3, 2008 | 30 | $990.00 | $250.00 | $330.00 |
| 587 | Dec. 9, 2008 | 16 | $600.00 | $0.00 | $150.00 |
| | | 46 | $1,590.00 | $250.00 | $480.00 |

CHART 9
Radiology Charge Detail Provider Payment Breakdown

| | INCURD_DT | HCPCS | BILLED | A/P | Payer Pmt |
|---|---|---|---|---|---|
| Radiology- | Dec. 5, 2008 | 71010 | $42.00 | $10.00 | $15.00 |
| 589 | Dec. 6, 2008 | 71010 | $42.00 | $10.00 | $15.00 |
| | Dec. 7, 2008 | 71010 | $42.00 | $10.00 | $15.00 |
| | Dec. 8, 2008 | 71020 | $52.00 | $13.00 | $18.00 |
| | Dec. 9, 2008 | 71010 | $42.00 | $10.00 | $15.00 |
| | Dec. 10, 2008 | 71020 | $52.00 | $13.00 | $18.00 |
| | Dec. 10, 2008 | 76604 | $125.00 | $30.00 | $45.00 |
| | Dec. 11, 2008 | 71020 | $52.00 | $13.00 | $18.00 |
| | Dec. 14, 2008 | 71010 | $42.00 | $10.00 | $15.00 |
| | Dec. 14, 2008 | 71020 | $52.00 | $13.00 | $18.00 |
| | Dec. 14, 2008 | 71020 | $52.00 | $13.00 | $18.00 |
| | | | $595.00 | $145.00 | $210.00 |

### ACB Package Provider Payment Distribution on EOB

After the payment distribution amount is determined for each provider by specialty, checks are processed and Explanations of Benefits (EOBs) are generated. A unique feature of the present disclosure with regards to explanations of benefit is the configuration to show the application of a single bundled payment across submitted charges by the provider. In this way, each provider is able to post the single payment across charge line items, thus avoiding unnecessary debit or credit balances on the entire claim. The EOB logic uses the percentage of the total submitted charges for each provider specialty which is divided by each individual charge. Once a percentage is identified for each charge item, it is applied against the single, bundled provider payment and divided proportionately across each individual charge. The diagram below reflects the Explanation of Benefit created for the Cardiology charges where a $500 payment from the majority of care rule was distributed across the three submitted charges.

EXPLANATION OF BENEFITS

| | | | |
|---|---|---|---|
| Payee: | Your Office Name | | |
| | 6624 Fannin, Suite 00000 | | |
| | Houston, TX 77030 | Check Date: ##### | Check Number: 33332 |

| | | | | | | | | | | | | | | | | |
|---|---|---|---|---|---|---|---|---|---|---|---|---|---|---|---|---|
| | | | | | Claim Charges | | Plan | | | | | | | Payment | Pkg Posting | Comment |
| CPT Code | Mod | Date of Service | Units | Claim Billed | in Pkg | Pkg Payable | Allowed | Plan Disallow | Deduct | Copay | Co-ins | Misc | Withhold | Amount | Distribution | Codes |

| | |
|---|---|
| Patient: Smith, John | SSN: 123-44-5678 |

| | |
|---|---|
| Claim Control #: C20030626.0.103 | Claim # 1040011 |

| | | | | | | | Carrier: XXXX | | | | Plan: XXXX 01 | | | | |
|---|---|---|---|---|---|---|---|---|---|---|---|---|---|---|---|
| ACB | Jun. 16, 2003 | 1 | 0.00 | 2,170.00 | 500.00 | 500.00 | 0.00 | 0.00 | 0.00 | 0.00 | 0.00 | 0.00 | 500.00 | | 90 |
| 99232 | Dec. 5, 2008 | 1 | $1,500.00 | | | 345.62 | 0.00 | 0.00 | 0.00 | 0.00 | 0.00 | 0.00 | 0.00 | 345.62 | 99 |
| 99233 | Dec. 5, 2008 | 1 | $360.00 | | | 82.95 | 0.00 | 0.00 | 0.00 | 0.00 | 0.00 | 0.00 | 0.00 | 82.95 | 99 |
| 99254 | Dec. 5, 2008 | 1 | $310.00 | | | 71.43 | 0.00 | 0.00 | 0.00 | 0.00 | 0.00 | 0.00 | 0.00 | 71.43 | 99 |
| | | | $ 2,170.00 | | 500.00 | 500.00 | 0.00 | 0.00 | 0.00 | 0.00 | 0.00 | 0.00 | 500.00 | 500.00 | |

```
CODES
  5 Deductible
  6 Co-Payment
  7 Co-insurance
90 Bundle Package Line Item
99 Bundled into above package
```

Another unique feature of some embodiments of the present disclosure is when a provider utilizes the disclosed practice management system, the submitted charges are automatically migrated to the BMSO claims processing system (without the need to utilize an external EDI transmission process), and the payment and EOB is automatically posted via a payment migration process. This is a unique and more efficient claims capture and posting process which reduces errors through automation and eliminates the need to move claim information externally to the system. The automatic payment posting process through data migration is accomplished by systematically identifying the provider and the respective open accounts receivable charges and then applying payment directly to the charges.

### EXAMPLE CONCLUSION

In summary, out of the 85 provider submitted charges that were attached to the ACB Package with gross total billed charges from providers totaling $32,135 for this example, the BMSO distributed $8,150 across seven provider specialties for the bundle and billed the payer $8,515 in accordance with bundled services contracts. In contrast, on a traditional FFS basis, the payer in this case study example would have paid $13,503 based on its average market rates, costing the payer an additional $4,988 or 58% more than what it could have paid under a bundled services arrangement with the BMSO. In addition to saving money, the payer would have also saved time and resources in processing 85 charges instead of one bundled package claim charge. The patient would have also saved time and money with only one patient statement and would have been able to make a more informed decision by knowing a single transparent price upfront.

While the provider net margin on the ACB package reflects a net loss of $150 in this case study, the providers understand the accountability for the assumption of such shared risk for each case performed. The entire episode of care in this example, however, does produce a small, positive net margin of $105 because the complications of this ACB package caused the LOS threshold to be exceeded and additional remuneration was made by the payer. All net margins for each episode, positive or negative, are accrued to the shared risk pool. Any balances remaining over a specified time period are distributed by the BMSO to the involved contracted providers. This distribution to each contracted provider may be weighted based on each provider meeting certain goals—clinical, utilization, cost and other administrative guidelines attained.

Using systematic process and technology involved in the present disclosure to address independent practitioners coming together under bundled pricing arrangements to reduce both clinical service and administrative costs in healthcare, is both innovative and unique.

### REFERENCES CITED

The following references, to the extent that they provide exemplary procedural or other details supplementary to those set forth herein, are specifically incorporated herein by reference.
Miller, Harold D. “How to Create Accountable Care Organizations” First Edition, Sep. 7, 2009, Center for Healthcare Quality and Payment Reform.

What is claimed:

1. A process for administration of bundled healthcare pricing, comprising:
electronically compiling a database of patient information;
electronically calculating historical costs of a healthcare bundle using a data processor and probability data generated from the database;
establishing a fee for the healthcare bundle as a function of the historical costs;
electronically identifying one more bundled cases, each of the bundled cases included episode data and package data, using the data processor;
electronically transmitting a notification of the bundled cases and associated episode data and package data to one or more healthcare providers;
assembling one or more claims from each of the healthcare providers into a single episode case associated with one of the bundled cases;
submitting the one or more claims for the single episode case to one or more of the group comprising secondary insurance carriers, employer groups, third party payers and beneficiaries;
collecting fees for the one or more claims for the single episode case from one or more of the beneficiaries, the secondary insurance carriers, the employer groups, the third party payers and the beneficiaries;
distributing payment to the one or more healthcare providers;
electronically determining whether a positive balance or negative balance exists for the single episode case based on the associated bundled case;
distributing the positive balance for the single episode case to the one or more healthcare providers if it is determined that the positive balance exists; and
requesting subscription for the single episode case from the one or more healthcare providers if it is determined that the negative balance exists.

2. The process of claim 1, wherein electronically compiling the database of patient information comprises electronically compiling data associated with one or more of the group comprising diagnosis, surgical procedure, postoperative course, medical history information, and personal demographic data.

3. The process of claim 1, wherein one or more of the bundled cases comprises data from the group comprising acute case data, inpatient hospital services data, physician services data, outpatient hospital services data and post-acute care services data.

4. The process of claim 1, wherein one or more of the bundled cases comprises fee data for services from multiple physicians or multiple facilities.

5. The process of claim 1, further comprising verifying beneficiary coverage with secondary carriers before providing services.

6. The process of claim 1, further comprising:
receiving denial of coverage data from the secondary insurance carriers; and
modifying one or more the bundled cases as a function of the denial of coverage data.

7. The process of claim 1 wherein assembling the one or more claims from each of the healthcare providers into the single episode case associated with one of the bundled cases comprises:
applying a majority of care rule to identify a first subset of the one or more healthcare providers that will share the positive balance or the negative balance for the single episode case; and
applying the majority of care rule to identify a second subset of the one or more healthcare providers that will be compensated on a fee for services basis only.

8. The process of claim 1 wherein assembling the one or more claims from each of the healthcare providers into the single episode case associated with one of the bundled cases comprises:
calculating a first amount based on bundled care pricing for the single episode case;
calculating a second amount based on fee for service pricing for the single episode case; and
generating a report comparing the first amount and the second amount.

9. The process of claim 1 wherein distributing the payment to the one or more healthcare providers comprises:
determining an allocation of a single distribution amount to be applied to each of the one or more claims received from one of the healthcare providers; and
generating a line item amount for each of the claims in an explanation of benefits record for the healthcare provider.

10. A process for administration of bundled healthcare pricing, comprising:
electronically receiving and storing one or more data fields in a nontransitory data storage medium with an associated bundled case episode identifier;
generating a unique case identifier for the bundled case episode identifier;
electronically transmitting the unique case identifier to one or more providers;
electronically receiving claims from the one or more providers associated with the unique case identifier;
determining with a data processor whether a claim with a master procedural or a diagnosis code is present in the claims for the unique case identifier; and
modifying the bundled case episode identifier for the unique case identifier if the claim with the master procedural code or the diagnosis code is present.

11. The process of claim 10 further comprising determining whether the claim is inclusive or exclusive of an outlier parameter for the bundled case rate.

12. The process of claim 11 further comprising:
determining whether the case exceeds one or more of a fixed LOS, a predetermined price or a predetermined number of related services for the bundled case rate; and
computing outlier provisions if the case exceeds the fixed LOS, the predetermined price or the predetermined number of related services for the bundled case rate.

13. The process of claim 12 further comprising automatically calculating a case rate for the bundled case rate, including the outlier provisions.

14. The process of claim 13 further comprising automatically calculating the accounts payable (AP) to providers associated with the unique case identifier.

15. The process of claim 14 further comprising calculating a net margin per case prior to potential risk pool claims.

16. The process of claim 15 further comprising submitting a repriced bundled claim to a third party payer.

17. The process of claim 16 further comprising automatically providing claim status data to the one or more providers, the claim status data comprising one or more of the group comprising billed claim data, claim processing in process data, claim denied for more information required data, and claim paid data.

18. The process of claim 10 wherein electronically receiving and storing the one or more data fields in the nontransitory data storage medium with the associated bundled case episode identifier comprises:
migrating a first subset of the one or more data fields from associated internal data fields for a practice management system; and
receiving a second subset of the one or more data fields by processing external data records.

19. A process for administration of bundled healthcare pricing, comprising:
electronically receiving payment data for one or more episodes of care from one or more of the group comprising one or more insurance companies, one or more employer groups, one or more third party payers and one or more individual patients;
electronically receiving electronic funds transfer (EFT) data and associated explanation of benefits (EOB) data for the payment data;
electronically storing episode of care data, the payment data, the EFT data and the EOB data for each of the one or more episodes of care;
generating provider EOB data as a function of the payment data, the EFT data, the EOB data and bundled case data for each of the one or more episodes of care;
determining a final net margin for a plurality of episodes of care after a predetermined period of time;
distributing a positive balance of the final net margin to one or more risk pool providers; and
requesting subscription for the final net margin from the one or more risk pool providers.
